(19) United States
(12) Patent Application Publication
(10) Pub. No.: US 2026/0241981 A1
(43) Pub. Date: Aug. 20, 2026

(54) VEHICLE STEERING APPARATUS

(71) Applicant: HL MANDO CORPORATION, Gyeonggi-do (KR)

(72) Inventors: Hyunbi KWON, Gyeonggi-do (KR); Jaehoon BAE, Gyeonggi-do (KR); Jihoon PARK, Gyeonggi-do (KR); Hyun KIM, Gyeonggi-do (KR)

(21) Appl. No.: 19/542,627

(22) Filed: Feb. 17, 2026

(30) Foreign Application Priority Data
Feb. 18, 2025 (KR) 10-2025-0020542
Dec. 1, 2025 (KR) 10-2025-0186847

(51) Int. Cl. B62D 5/04; B62D 5/00

(52) U.S. Cl. CPC B62D 5/0424; B62D 5/006; B62D 5/0403; B62D 5/0409; B62D 5/046

(57) ABSTRACT

A vehicle steering apparatus includes a rotatable nut operably coupled to a rack bar and sliding the rack bar in an axial direction, a first nut pulley provided on an outer surface of the rotatable nut, a second nut pulley provided on the outer surface of the ball nut, a first motor pulley coupled to a first motor and connected to the first nut pulley via a first belt, a second motor pulley coupled to a second motor and connected to the second nut pulley via a second belt, an angle sensor accommodated in a steering column and coupled to a steering shaft, detecting a rotational angle and/or direction of the steering shaft, and transmitting the detected rotational angle and/or direction as an electrical signal, and a controller controlling the first and second motors based on the electrical signal received from the angle sensor.

### CROSS-REFERENCE TO RELATED APPLICATIONS

This application claims the priorities to and the benefits of Korean Patent Application No. 10-2025-0020542, filed on Feb. 18, 2025, and Korean Patent Application No. 10-2025-0186847, filed on Dec. 1, 2025, in the Korean Intellectual Property Office, the disclosures of which are incorporated herein by reference in their entireties.

### BACKGROUND

### Field

Some embodiments of the present disclosure generally relate to a vehicle steering apparatus.

### Description of the Related Art

Power steering systems have been used in a vehicle steering apparatus to provide convenience in a driving operation by assisting an operating force applied to a steering wheel by a driver. The power steering system may include a hydraulic system that utilizes hydraulic pressure, an electro-hydraulic system that utilizes both hydraulic and motor-driven power, and an electric system that utilizes only motor-driven power.

Recently, a steer-by-wire (SBW) steering apparatus has been developed. The SBW steeing apparatus uses an electric motor such as a motor for steering the vehicle and may not have a mechanical connection between a steering wheel and road wheels such as a steering shaft, universal joint, or pinion shaft.

However, because the steer-by-wire steering apparatus does not have mechanical connection between the steering shaft and the road wheel, the driver's steering manipulation cannot be transmitted to the rack bar in the event of a failure of the motor, and the rack bar may be rotated by rotational torque of a ball nut, thereby degrading steering stability.

In addition, since there is no mechanical connection between the steering shaft and the road wheel, there is a need for control technologies for addressing failure situations and precisely controlling motors associated with the steering wheel and the road wheel.

Therefore, there is a growing need for a technology to stably control the rack bar based on the driver's steering intention and perform a stable steering operation in the steer-by-wire systems and the power steering systems.

### SUMMARY

Some embodiments of the present disclosure may provide a stable and effective vehicle steering apparatus.

According to the present embodiments, there may be provided a vehicle steering apparatus, including: a ball nut coupled to a rack bar via a ball to rotate and sliding the rack bar in an axial direction; a first nut pulley provided on an outer peripheral surface of the ball nut; a second nut pulley provided on the outer peripheral surface of the ball nut; a first motor pulley coupled to a first motor and connected to the first nut pulley via a first belt; a second motor pulley coupled to a second motor and connected to the second nut pulley via a second belt; an angle sensor that is accommodated in a steering column and coupled to a steering shaft, detects a rotational angle and direction of the steering shaft, and transmits the detected rotational angle and direction as an electrical signal; and an electronic control device that controls an output value transmitted to the first and second motors using an electrical signal received from the angle sensor as an input value.

In the present embodiments, the steering column may further include a rotation angle limiting device coupled to the steering shaft to limit the rotation angle of the steering shaft, and a steering column motor coupled to the steering shaft to rotate the steering shaft.

In the present embodiments, the steering column may further include a coupler that connects a shaft of the steering column motor and the steering shaft.

In the present embodiments, the coupler may be formed in a cylindrical shape and have teeth formed on an inner peripheral surface thereof that are long in a direction of the steering shaft, such that a shaft of the steering column motor is tooth-coupled to an inner side of one end and the steering shaft is tooth-coupled to an inner side of the other end.

In addition, in the present embodiments, the rotation angle limiting device may include a first rotation member having a fixing hole coupled to the steering shaft and rotating in conjunction with the steering shaft, a second rotation member having a through hole rotatably coupled to the steering shaft and supported by one end of the first rotation member and rotating if the steering shaft rotates, and a housing that accommodates the angle sensor and the rotation angle limiting device and includes an inner peripheral surface supporting one end of the second rotation member and a stopper that limits rotation.

In the present embodiments, the angle sensor, the first rotation member, and the second rotation member may be accommodated in an inner space of the housing, the housing may have a small diameter portion with a reduced inner diameter at one end thereof, and a bearing that supports one end of the steering shaft may be coupled to the small diameter portion.

In addition, in the present embodiments, an inner ring of the bearing may be supported in a direction of the steering shaft by an inner ring fixing member screw-coupled to an outer peripheral surface of the steering shaft.

In the present embodiments, an outer ring of the bearing may be supported in a direction of the steering shaft by an outer ring fixing member coupled to a fixing groove formed on the inner peripheral surface of the housing.

In the present embodiments, the first rotation member may be supported in the direction of the steering shaft by a shaft fixing member screw-connected to the outer peripheral surface of the steering shaft.

In addition, in the present embodiments, the rotation angle limiting device may further include a rotation support member coupled to the through hole of the second rotation member and an outer peripheral surface of the steering shaft to support the rotation of the second rotation member.

In the present embodiments, the rotation support member may be formed in a ring shape with one side cut off and have a circumferential groove on the outer peripheral surface, and an inner peripheral surface of the through hole may be seated on the circumferential groove.

In addition, in the present embodiments, the first rotation member may include a ring-shaped first main body having the fixing hole, and a first support portion extending radially from an outer peripheral surface of the first main body to support and rotate the second rotation member.

In addition, in the present embodiments, the second rotation member may include a ring-shaped second main body having the through hole, and a second support portion extending radially from an outer peripheral surface of the second main body and protruding toward the steering shaft and supported by the first support portion.

In addition, in the present embodiments, a support groove may be provided, in which an elastic member is coupled to the second support portion and one side of the elastic member is supported by the first support portion.

In addition, in the present embodiments, the stopper may be provided with a seating groove by which the other side of the elastic member is supported.

In addition, according to the present embodiments, there may be provided a vehicle steering apparatus including: a steering shaft to which a steering wheel is coupled; an angle sensor that is coupled to the steering shaft, detects a rotational angle and direction of the steering shaft, and transmits the detected rotational angle and direction as an electrical signal; a rotation angle limiting device coupled to the steering shaft to limit the rotation angle of the steering shaft; and a steering column motor coupled to the steering shaft to rotate the steering shaft.

In addition, in the present embodiments, the rotation angle limiting device may include a screw cylinder having a cylindrical shape to which the steering shaft is coupled and an outer threaded portion formed on an outer peripheral surface thereof, and rotating in conjunction with the steering shaft, a cylinder nut having an inner threaded portion formed on an inner peripheral surface thereof to engage the outer threaded portion and a guide formed on an outer peripheral surface thereof extending radially, and moving in a direction of the steering shaft if the screw cylinder rotates, and a housing coupled to the steering column motor, accommodating the screw cylinder and the cylinder nut, and having a guide groove formed on the inner peripheral surface thereof into which the guide is inserted and supported.

In addition, in the present embodiments, a nut support end that has an enlarged diameter and stops movement of the cylinder nut in one direction may be provided on one side of the screw cylinder, and a nut support member that stops movement of the cylinder nut in an opposite direction may be coupled to the other side of the screw cylinder.

Furthermore, in the present embodiments, a first enlarged portion having an enlarged diameter may be provided on one outer peripheral surface of the steering shaft, the angle sensor may be disposed on one side of the first enlarged portion, and the nut support end may be disposed on the other side of the first enlarged portion to be supported in the direction of the steering shaft.

Furthermore, in the present embodiments, a second enlarged portion having an enlarged diameter may be provided on the other outer peripheral surface of the steering shaft, a nut support member may be disposed on one side of the second enlarged portion, and a bearing may be disposed on the other side of the second enlarged portion to be supported in the direction of the steering shaft.

Furthermore, in the present embodiments, an outer ring of the bearing may be supported in a direction of the steering shaft by an outer ring fixing member coupled to a fixing groove formed on the inner peripheral surface of the housing.

Furthermore, in the present embodiments, an inner ring of the bearing may be supported in a direction of the steering shaft by an inner ring fixing member screw-coupled to an outer peripheral surface of the steering shaft.

In addition, in the present embodiments, the vehicle steering apparatus may further include a coupler that connects the shaft of the steering column motor and the steering shaft.

In addition, in the present embodiments, the coupler may be formed in a cylindrical shape and have teeth formed on an inner peripheral surface thereof that are long in a direction of the steering shaft, such that the shaft of the steering column motor is tooth-coupled to an inner side of one end and the steering shaft is tooth-coupled to an inner side of the other end.

Certain embodiments of the present disclosure can provide a stable and effective vehicle steering apparatus.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic diagram illustrating a vehicle steering apparatus according to an embodiment of the present disclosure;

FIGS. 2 to 7 are partial views illustrating a vehicle steering apparatus according to an embodiment of the present disclosure;

FIG. 8 is a schematic diagram illustrating a vehicle steering apparatus according to an embodiment of the present disclosure;

FIGS. 9 to 18 are partial views illustrating a vehicle steering apparatus according to an embodiment of the present disclosure;

FIG. 19 is a graph for illustrating a method for estimating a rack bar position based on difference between first rotation information of a first motor and second rotation information of a second motor according to an embodiment of the present disclosure;

FIGS. 20 to 23 are perspective views illustrating a vehicle steering apparatus according to an embodiment of the present disclosure;

FIG. 24 is a cross-sectional view illustrating a vehicle steering apparatus according to an embodiment of the present disclosure;

FIGS. 25 to 29 are perspective views illustrating a vehicle steering apparatus according to an embodiment of the present disclosure; and

FIG. 30 is a cross-sectional view illustrating a vehicle steering apparatus according to an embodiment of the present disclosure.

### DETAILED DESCRIPTION OF THE EMBODIMENT

In the following description of examples or embodiments of the present disclosure, reference will be made to the accompanying drawings in which it is illustrated by way of illustration specific examples or embodiments that can be implemented, and in which the same reference numerals and signs can be used to designate the same or like components even when they are illustrated in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements or the like, but is used merely to distinguish the corresponding element from other elements.

When it is mentioned that a first element “is connected or coupled to”, “contacts or overlaps” or the like a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, or the like each other via a fourth element. Here, the second element may be included in at least one of two or more elements that “are connected or coupled to”, “contact or overlap”, or the like each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes or the like are mentioned, it should be considered that numerical values for an elements or features, or corresponding information (for example, level, range, or the like) include a tolerance or error range that may be caused by various factors (for example, process factors, internal or external impact, noise, or the like) even when a relevant description is not specified. Further, the term “may” fully encompass all the meanings of the term “can”.

Unlike the conventional structure where the steering wheel is physically connected to the wheels, the steer-by-wire steering apparatus uses electronic signals of wires to move the vehicle according to steering control of a driver. Vehicle motion control using wires may be applied to various parts such as brakes. However, in the case of steer-by-wire steering apparatus, stable technical support is required as there is a possibility that the vehicle may become uncontrollable due to interruption of the electronic signal. In addition, technological advancements in miniaturization and manufacturing cost are also required.

Various structural and control technologies according to some embodiments of the present disclosure may satisfy stability, miniaturization, and manufacturing cost in the steer-by-wire steering apparatus. For example, certain embodiments of the present disclosure may include a plurality of motors for moving a rack bar to ensure redundancy and provide appropriate torque. Various embodiments are also described based on various effects regarding the arrangement of the motors and rack bar.

When a steering apparatus according to an embodiment of the present disclosure is applied to a steer-by-wire system, a pinion may be eliminated, thereby reducing cost and miniaturization. However, in this case, the rack bar may rotate as the rack bar moves according to the driving of a motor. The present disclosure presents various embodiments of a structure for an anti-rotation means or member to solve this problem.

In addition, precise estimation of an absolute position of a rack bar in a steer-by-wire steering apparatus is required for accurate steering of a vehicle. However, a sensor for estimating the absolute position of the rack bar may be vulnerable to shock, dust, water, or similar environmental factures. In addition, multiple sensors may be required to ensure redundancy. The present disclosure discloses various embodiments for estimating the position of the rack bar by using an absolute angle sensor for estimating the position of the rack bar or by using a sensor provided in a motor, or the like. In addition, an embodiments in which the position of the rack bar is relatively estimated may provide a specific operation of a control device for estimating the position of the rack bar.

The structure, motor, anti-rotation member, sensor, and control operation of the steering apparatus described in the present disclosure each have various embodiments. The embodiments for each part may be implemented in the steering apparatus in any combination.

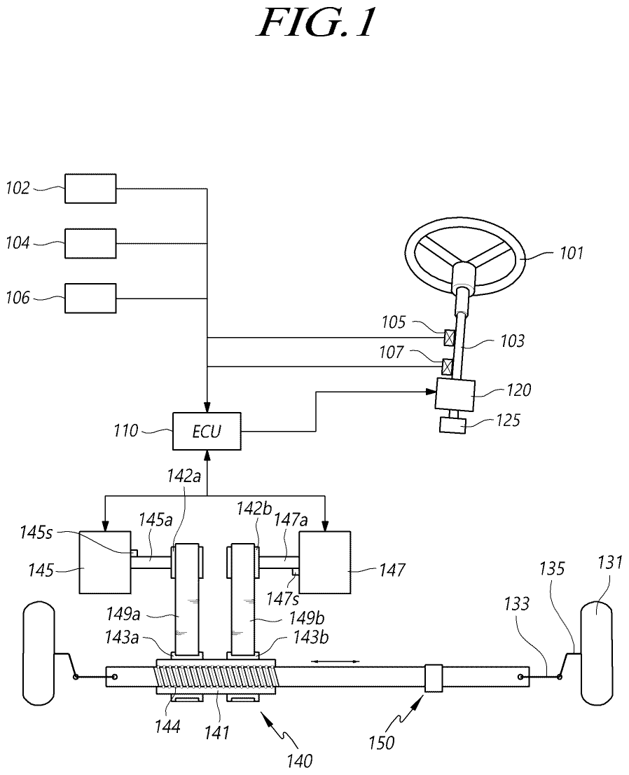

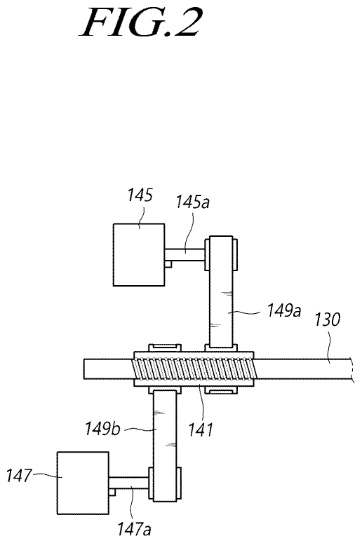

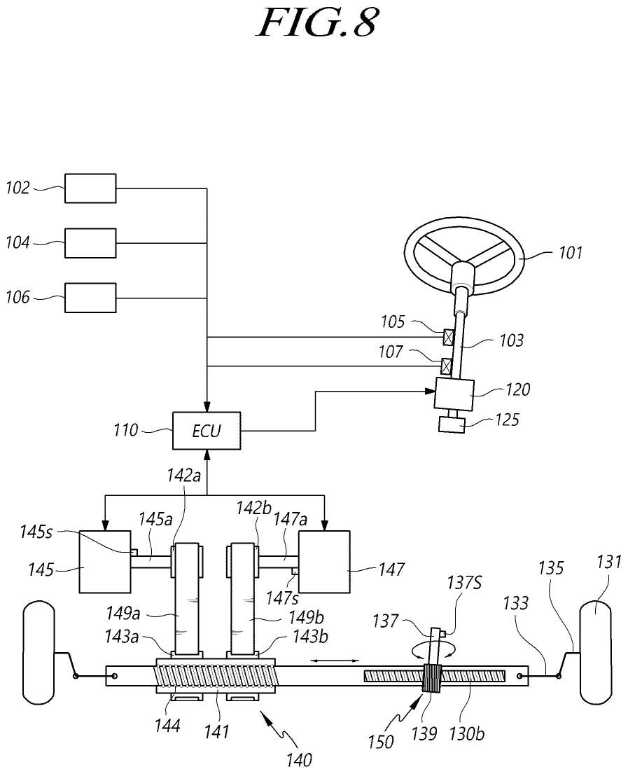

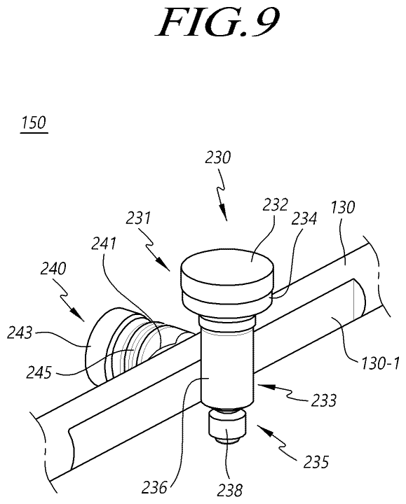

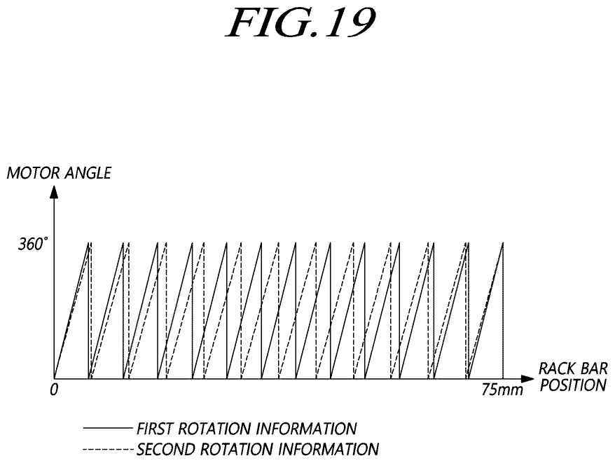

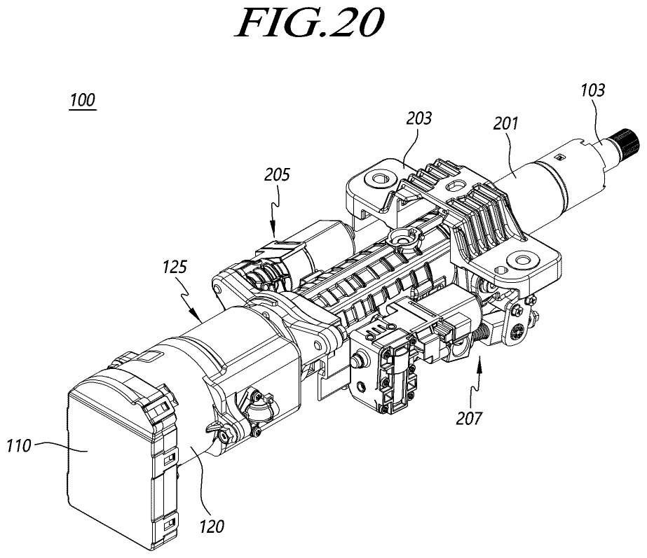

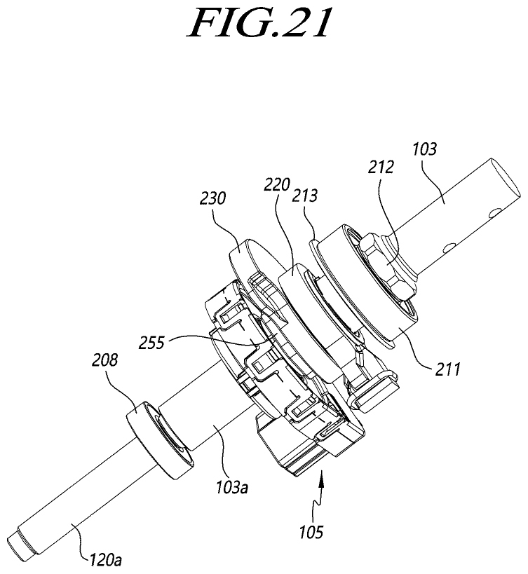

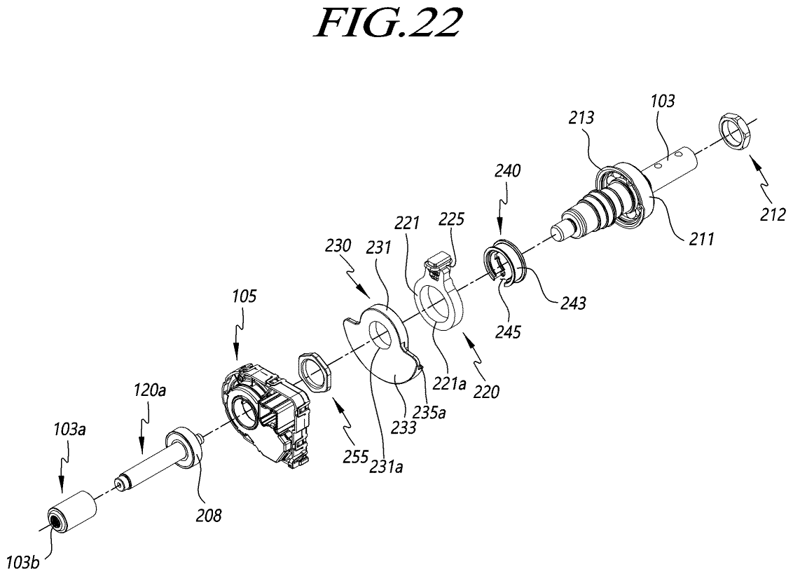

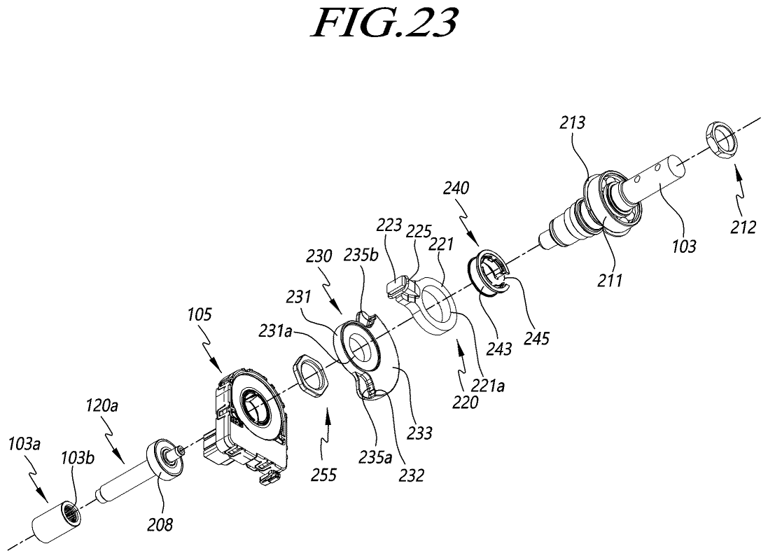

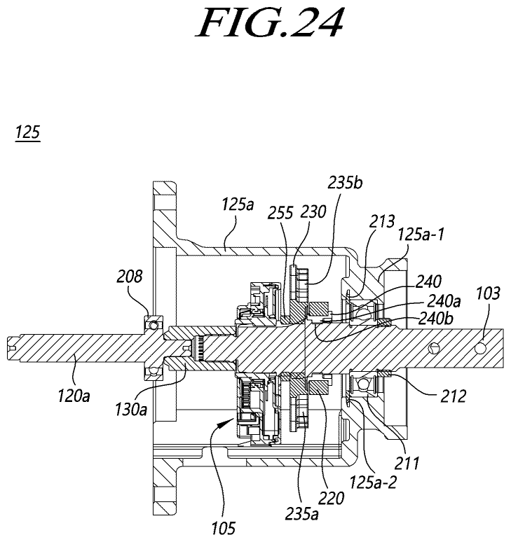

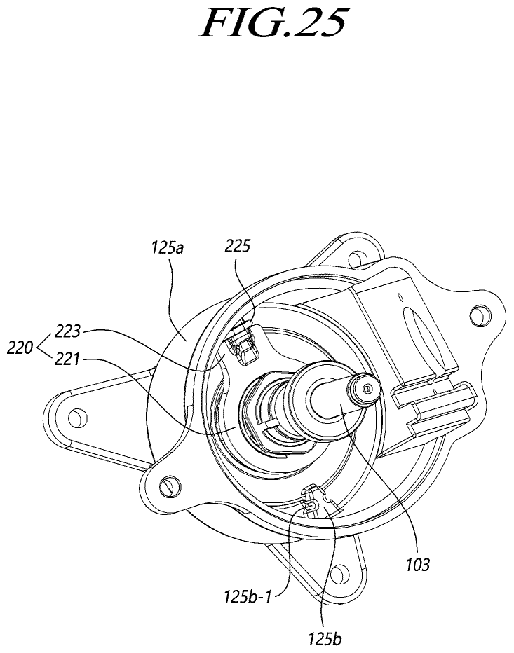

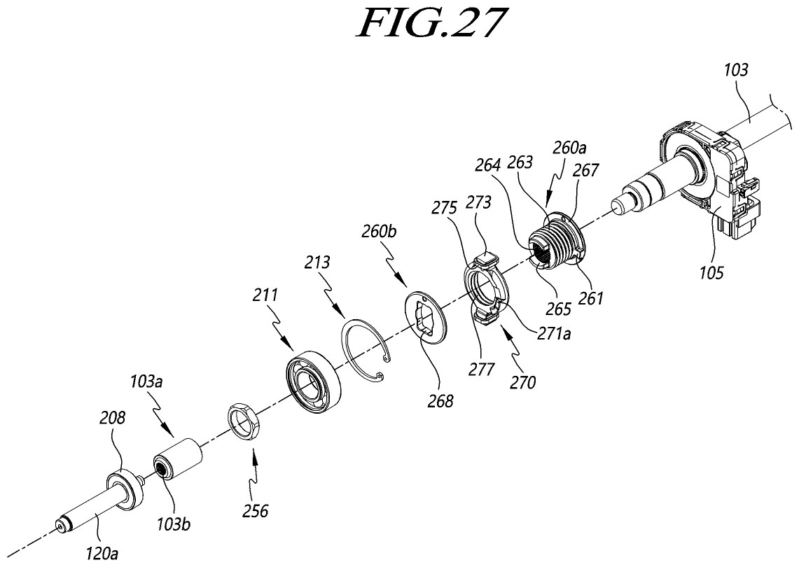

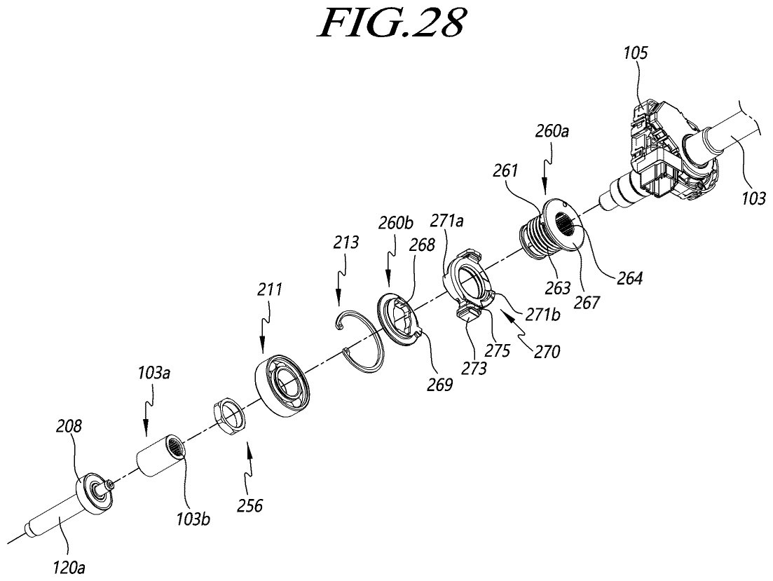

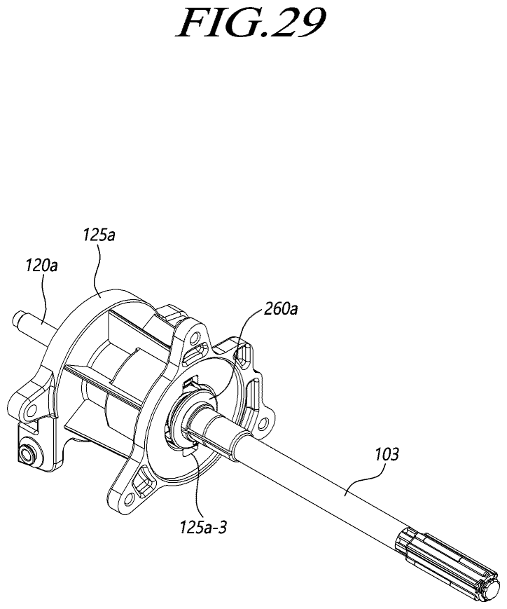

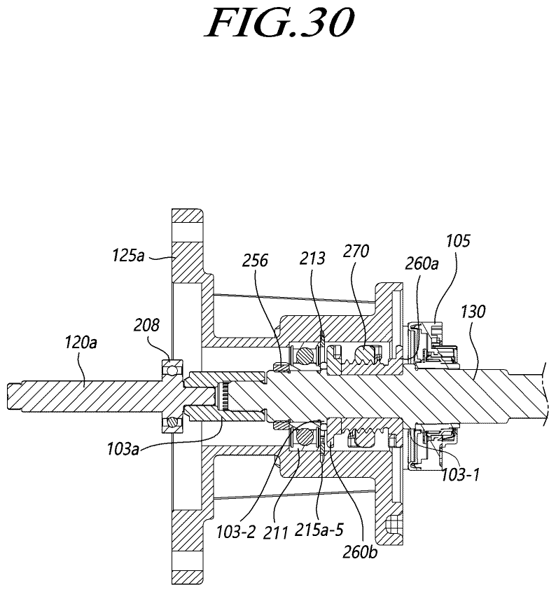

FIG. 1 is a schematic diagram illustrating a vehicle steering apparatus according to an embodiment of the present disclosure, FIGS. 2 to 7 are plan views illustrating a portion of the vehicle steering apparatus according to an embodiment of the present disclosure, FIG. 8 is a schematic diagram illustrating the vehicle steering apparatus according to an embodiment of the present disclosure, FIGS. 9 to 18 are views illustrating a portion of the vehicle steering apparatus according to an embodiment of the present disclosure, FIG. 19 is a diagram illustrating a method for estimating a rack stroke range based on the difference between first and second rotation information according to the present embodiment, FIGS. 20 to 23 are perspective views illustrating the vehicle steering apparatus according to an embodiment of the present disclosure, FIG. 24 is a cross-sectional view illustrating the vehicle steering apparatus according to an embodiment of the present disclosure, FIGS. 25 to 29 are perspective views illustrating the vehicle steering apparatus according to an embodiment of the present disclosure, and FIG. 30 is a cross-sectional view illustrating the vehicle steering apparatus according to an embodiment of the present disclosure.

The vehicle steering apparatus according to an embodiment of the present disclosure may include a ball nut operably coupled to a rack bar via a ball to rotate and configured to slide or move the rack bar in an axial direction, a first nut pulley provided on an outer peripheral surface of the ball nut, a second nut pulley provided on the outer peripheral surface of the ball nut, a first motor pulley coupled to a first motor and connected to the first nut pulley via a first belt, a second motor pulley coupled to a second motor and connected to the second nut pulley via a second belt, an angle sensor 105 that is accommodated in a steering column and coupled to a steering shaft, detects a rotational angle and/or direction of the steering shaft, and transmits the detected rotational angle and direction as an electrical signal, and an electronic control device 110 that controls an output value transmitted to the first and second motors using an electrical signal received from the angle sensor 105 as an input value.

In addition, the vehicle steering apparatus according to an embodiment of the present disclosure may include a steering shaft to which a steering wheel is coupled, an angle sensor 105 that is coupled to the steering shaft, detects a rotational angle and/or direction of the steering shaft, and transmits the detected rotational angle and direction as an electrical signal, a rotation angle limiting device 125 coupled to the steering shaft to limit the rotation angle of the steering shaft, and a steering column motor 120 coupled to the steering shaft to rotate the steering shaft. With reference to FIG. 1, in a steering apparatus according to the present disclosure, an angle sensor 105 and a torque sensor 107 may be coupled to one side of a steering shaft 103 connected to a steering wheel 101 or located around the steering shaft 103.

In an autonomous driving mode in which an autonomous driving system is driving the vehicle or in a driver assistance mode in which an driver assistance system such as an Advanced Driver Assistance System (ADAS) is assisting a driver with the operation of the vehicle, the electronic control device 110 controls a steering shaft motor 120, the first motor 145, and the second motor 147 by transmitting one or more control signals to the steering shaft motor 120, the first motor 145, and the second motor 147 in response to electrical signals transmitted from various sensors mounted in or to or associated with a vehicle.

In a driver driving mode, the electronic control device 110 controls the steering shaft motor 120, the first motor 145, and the second motor 147 by outputting one or more control signals to the steering shaft motor 120, the first motor 145, and the second motor 147 in response to electrical signals transmitted from the angle sensor 105, which detects a manipulation or rotation angle of the steering wheel 101 by the driver, electrical signals transmitted from the torque sensor 107, and electrical signals transmitted from various other sensors mounted in or to or associated with the vehicle.

In an embodiment illustrated in FIG. 1, the angle sensor 105 and the torque sensor 107 are provided as two separate and individual sensors. Alternatively, the angle sensor 105 and the torque sensor 107 may be integrated into one single sensor such as one torque angle sensor.

The steering shaft motor 120 may be connected to or associated with a speed reducer configured to reduce a rotational speed of the steering shaft motor 120 including, for example, but not limited to, one or more gears, one or more pulleys, and/or one or more belts.

During normal driving, the steering shaft motor 120 provides appropriate steering feedback to the driver by providing a reaction force to the steering shaft 103 so that the driver may feel a steering reaction force against the driver's manipulation of the steering wheel 101. The steering shaft motor 120 may be also referred to as a reaction force motor. However, as described below, the steering shaft motor 120 may not only provide the reaction force but also operate in accordance with autonomous steering when the steering shaft motor 120 operates in the autonomous driving mode.

In addition, the steering shaft motor 120 rotates the steering shaft 103 so that the autonomous steering can be performed under the control of the electronic control device 110 without the involvement of the driver's driving or intention when the steering shaft motor 120 operates in the autonomous driving mode.

Further, in a steer-by-wire steering apparatus, because the steering wheel 101 is not mechanically connected to the rack bar 130 and a road wheel 131, a device for mechanically restricting or limiting a rotatable range of the steering wheel 101 may be included to prevent the steering shaft 103 from rotating infinitely when the driver manipulates the steering wheel 101.

For example, a rotation angle restriction device 125 may be provided to restrict or limit a rotatable range of the steering wheel 101 to prevent the steering shaft 103 from rotating infinitely.

The first motor 145 and the second motor 147 move the rack bar 130 or cause the rack bar 130 to slide by a rack bar moving device 140 in order to steer the road wheels 131, which are provided at or connected to two opposite sides of the rack bar 130 through tie rods 133 and knuckle arms 135 by sliding the rack bar 130.

The rack bar moving device 140 includes the ball nut 141, the first nut pulley 143a, the second nut pulley 143b, the first motor pulley 142a, and the second motor pulley 142b. The ball nut 141 may be rotatably coupled to the rack bar 130 by means of the balls 144 and configured to slide the rack bar 130 in the axial direction of the rack bar moving device 140 by the rotation of the ball nut 141. The first nut pulley 143a may be provided on one side of the outer peripheral surface of the ball nut 141, and the second nut pulley 143b may be provided on the other side of the outer peripheral surface of the ball nut 141. The first motor pulley 142a may be coupled to the first motor 145 (e.g. fixed to a shaft of the first motor 145) or directly formed on a rotatable part of the first motor 145 and connected to the first nut pulley 143a through the first belt 149a. The second motor pulley 142b may be coupled to the second motor 147 (e.g. fixed to a shaft of the second motor 147) or directly formed on a rotatable part of the second motor 147 and connected to the second nut pulley 143b through the second belt 149a.

Further, the balls 144 are rotatably disposed between a rack screw groove, which is formed on an outer peripheral surface of the rack bar 130, and a nut screw groove, formed on an inner peripheral surface of the ball nut 141, such that the rack bar 130 can slides in the axial direction of the rack bar moving device 140 by the rotation of the ball nut 141.

However, in the embodiments of the present disclosure described above, the angle sensor 105 and the torque sensor 107 are provided on or around the steering shaft 103, and the steering apparatus according to an embodiment of the present disclosure may comprise a vehicle speed sensor 102, an ultrasonic sensor 104, and an image sensor 106 for transmitting steering information to the electronic control device 110. However, various types of sensors, such as a radar and a lidar, may be added to an embodiment of the present disclosure.

In a steer-by-wire steering apparatus, because the steering wheel 101 is not mechanically connected to the rack bar 130 and the road wheel 131, a device mechanically restricting the rack bar 130 may be included to prevent the rack bar 130 from being rotated by rotational torque of the ball nut 141 rotated by the rack bar moving device 140.

For instance, a rotation prevention member 150 is configured to support the axial sliding of the rack bar 130 and prevent the rotation of the rack bar 130.

In an embodiment illustrated in FIG. 1, one single rotation prevention member 150 is provided at one side of the rack bar 130. Alternatively, a plurality of the rotation prevention members 150 may be provided to support the rack bar 130. The number of the rotation prevention members 150, an axial position of the rotation prevention member 150, or the like may vary depending on the configuration and required operations of the first and second motors 145 and 147 and necessary rotational force of the ball nut 141 of the rack bar moving device 140.

In one embodiment illustrated in FIG. 1, the first motor 145 and the second motor 147 are arranged to face each other such that a shaft 145a of the first motor 145 and a shaft 147a of the second motor 147 are aligned coaxially and disposed in parallel with a central axis of the rack bar 130.

In an another embodiment illustrated in FIG. 2, the first motor 145 is disposed on one side of the rack bar 130 and the second motor 147 is disposed on the other side of the rack bar 130 such that the rack bar 130 is positioned between the shaft 145a of the first motor 145 and the shaft 147a of the second motor 147, and the shaft 145a of the first motor 145 and the shaft 147a of the second motor 147 are disposed in parallel with the central axis of the rack bar 130 and disposed on two opposite sides of the central axis of the rack bar 130.

As described above, the exemplary arrangements of the first and second motors 145 and 147 and the rack bar 130 illustrated in FIGS. 1 and 2 may reduce the package size of the steering apparatus, making it more compact in volume, and the process of assembling of the steering apparatus the first motor 145, the first belt 149a, the second motor 147, and the second belt 149b may be simplified.

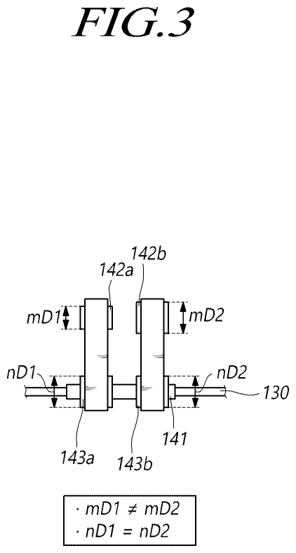

With reference to FIG. 3, an outer diameter mD1 of the first motor pulley 142a and an outer diameter mD2 of the second motor pulley 142b may be different from each other, and an outer diameter nD1 of the first nut pulley 143a and an outer diameter nD2 of the second nut pulley 143b may be equal to each other.

That is, the first nut pulley 143a and the second nut pulley 143b rotate while maintaining the same phase angle without a phase difference therebetween when the first motor 145 and the second motor 147 operate. The first motor pulley 142a and the second motor pulley 142b rotate while gradually changing a phase difference therebetween when the first motor 145 and the second motor 147 operate.

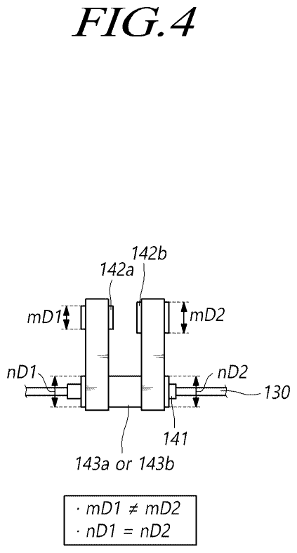

In an embodiment illustrated in FIG. 3, the first nut pulley 143a and the second nut pulley 143b are provided separately and connected to one portion and the other portion of the outer peripheral surface of the ball nut 141. However, as illustrated in FIG. 4, the first nut pulley 143a and the second nut pulley 143b may be integrated as a single piece having the same outer diameter. This will be described below.

The first motor 145 may have a first motor sensor 145s configured to detect a rotation position of the shaft 145a of the first motor 145, and the second motor 147 may have a second motor sensor 147s configured to detect a rotation position of the shaft 147a of the second motor 147.

When the first motor 145 operates, the first motor sensor 145s detects a direction and an angle of rotation of the shaft 145a of the first motor 145, and the first motor sensor 145s outputs a signal indicative of the direction and the angle to the electronic control device 110.

When the second motor 147 operates, the second motor sensor 147s detects a direction and an angle of rotation of the shaft 147a of the second motor 147, and the second motor sensor 147s outputs a signal indicative of the direction and the angle of the rotation of the shaft 147a of the second motor 147 to the electronic control device 110. When the second motor 147 operates, the second motor sensor 147s detects a direction and an angle of rotation of the shaft 147a of the second motor 147, and the second motor sensor 147s outputs a signal indicative of the direction and the angle of rotation of the shaft 147a of the second motor 147 to the electronic control device 110.

Therefore, the electronic control device 110 may determine a linear position of the rack bar 130 based on a first position of the shaft 145a of the first motor 145 detected by the first motor sensor 145s and a second position of the shaft 147a of the second motor 147 detected by the second motor sensor 147s and output a control signal to the first motor 145 and the second motor 147.

That is, the electronic control device 110 sets an angle between a reference point of the shaft 145a of the first motor 145 in a stopped state of the first motor 145 and a reference point of the shaft 147a of the second motor 147 in a stopped state of the second motor 147 to a reference position value. The electronic control device 10 sets an angle between the reference point of the shaft 145a of the first motor 145 and the reference point of the shaft 147a of the second motor 147 after the operations of the first and second motors 145 and 147 to an operating position value. The electronic control device 10 determines the linear position of the rack bar 130 based on a difference between the reference position value and the operating position value.

For instance, the difference between the reference position value and the operating position value may be set to 0° to 360°. A maximum slidable amount of the rack bar 130 is set within this range. The electronic control device 110 determines the slidable position of the rack bar 130 based on at least one of a rotation ratio between the first motor pulley 142a and the first nut pulley 143a, a rotation ratio between the second motor pulley 142b and the second nut pulley 143b, an outer diameter and an inner diameter of the ball nut 141, an outer diameter of the rack bar 130, or a lead angle between the rack screw groove 130a and the nut screw groove 141a.

In addition, the electronic control device 110 may determine the linear position of the rack bar 130 by setting the difference between the reference position value and the operating position value to a movement value and comparing the movement value with preset data. For instance, the movement value may be set to 0° to 360°, and the maximum slidable amount of the rack bar 130 may be set within this range.

The preset data may be data including the sliding amount of the rack bar 130 corresponding to the movement value determined based on at least one of the outer diameters of the first and second motor pulleys 142a and 142b, the outer diameters of the first and second nut pulleys 143a and 143b, the outer and inner diameters of the ball nut 141, and/or the outer diameter of the rack bar 130.

For example, the first motor pulley 142a and the second motor pulley 142b have different outer diameters, and the first nut pulley 143a and the second nut pulley 143b have the same outer diameter, such that the electronic control device 110 may determine the sliding position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

With reference to FIG. 4, the first nut pulley 143a and the second nut pulley 143b may be integrated to a single piece having the same outer diameter.

In an example that the first nut pulley 143a and the second nut pulley 143b are integrated to a single piece having the same outer diameter, the first belt 149a is coupled to one portion of the integrated pulley, and the second belt 149b is coupled to the other portion of the integrated pulley, such that the first belt 149a and the second belt 149b may be respectively connected to the first motor pulley 142a and the second motor pulley 142b.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

When the first motor 145 operates, the first motor sensor 145s detects the direction and the angle of the rotation of the shaft 145a of the first motor 145, and the first motor sensor 145s transmits the direction and the angle to the electronic control device 110.

When the second motor 147 operates, the second motor sensor 147s detects the direction and the angle of the rotation of the shaft 147a of the second motor 147 rotates, and the second motor sensor 147s transmits a signal indicative of the direction and the angle to the electronic control device 110.

Therefore, the electronic control device 110 may determine the linear position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

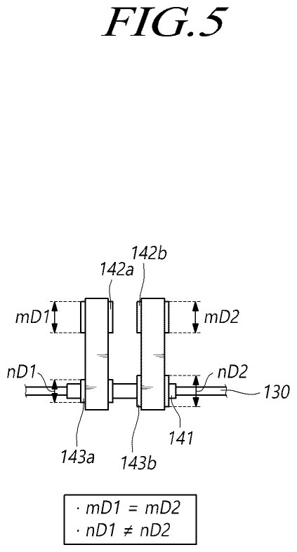

In an exemplary embodiment illustrated in FIG. 5, the outer diameter mD1 of the first motor pulley 142a and the outer diameter mD2 of the second motor pulley 142b may be equal to each other, and the outer diameter nD1 of the first nut pulley 143a and the outer diameter nD2 of the second nut pulley 143b may be different from each other.

The first nut pulley 143a, the second nut pulley 143b, and the ball nut 141 rotate at the same speed. Therefore, the first nut pulley 143a and the second nut pulley 143b maintain the same phase angle and rotate without a phase difference when the first motor 145 and the second motor 147 operate. However, the first motor pulley 142a and the second motor pulley 142b rotate while gradually changing a phase difference.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

When the first motor 145 operates, the first motor sensor 145s detects the direction and the angle of rotation of the shaft 145a of the first motor 145, and the first motor sensor 145s outputs a signal indicative of the direction and the angle of the rotation of the shaft 145a of the first motor 145 to the electronic control device 110.

Further, when the second motor 147 operates, the second motor sensor 147s detects the direction and the angle of rotation of the shaft 147a of the second motor 147, and the second motor sensor 147s transmits the direction and the angle of the rotation of the shaft 147a of the second motor 147 to the electronic control device 110.

Therefore, the electronic control device 110 may output a signal for controlling the first motor 145 and the second motor 147 by determining the linear position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

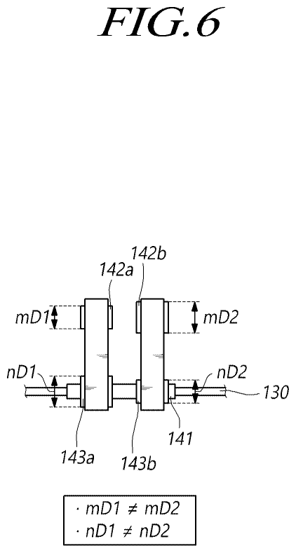

In an exemplary embodiment shown in FIG. 6, the outer diameter mD1 of the first motor pulley 142a and the outer diameter mD2 of the second motor pulley 142b may be different from each other, and the outer diameter nD1 of the first nut pulley 143a and the outer diameter nD2 of the second nut pulley 143b may also be different from each other.

Even in this case, the first nut pulley 143a, the second nut pulley 143b, and the ball nut 141 rotate at the same speed. Therefore, the first nut pulley 143a and the second nut pulley 143b maintain the same phase angle and rotate without a phase difference when the first motor 145 and the second motor 147 operate.

Further, the first motor pulley 142a and the second motor pulley 142b rotate while gradually changing a phase difference when the first motor 145 and the second motor 147 operate.

The first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the linear position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

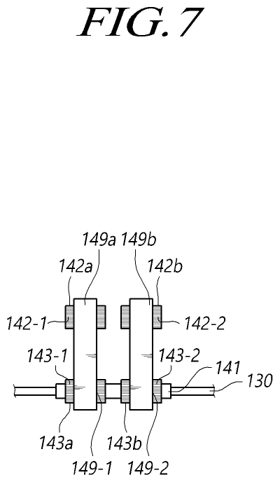

In an exemplary embodiment of FIG. 7, first motor pulley teeth 142-1 are provided on an outer peripheral surface of the first motor pulley 142a, and first nut pulley teeth 143-1 are provided on an outer peripheral surface of the first nut pulley 143a. The first motor pulley teeth 142-1 and the first nut pulley teeth 143-1 may be coupled to first belt teeth 149-1 provided on an inner peripheral surface of the first belt 149a.

Because the first motor pulley teeth 142-1 and the first nut pulley teeth 143-1 are coupled to the first belt teeth 149-1 to transmit power, the first motor pulley teeth 142-1 and the first nut pulley teeth 143-1 have the same size as the first belt teeth 149-1.

Second motor pulley teeth 142-2 are provided on an outer peripheral surface of the second motor pulley 142b, and second nut pulley teeth 143-2 are provided on an outer peripheral surface of the second nut pulley 143b. The second motor pulley teeth 142-2 and the second nut pulley teeth 143-2 may be coupled to second belt teeth 149-2 provided on an inner peripheral surface of the second belt 149b.

Because the second motor pulley teeth 142-2 and the second nut pulley teeth 143-2 are coupled to the second belt teeth 149-2 to transmit power, the second motor pulley teeth 142-2 and the second nut pulley teeth 143-2 may have the same size as the second belt teeth 149-2.

Further, the number of the first motor pulley teeth 142-1 and the number of the second motor pulley teeth 142-2 may be different from each other, and the number of the first nut pulley teeth 143-1 and the number of the second nut pulley teeth 143-2 may be equal to each other.

The first motor pulley teeth 142-1 and the second motor pulley teeth 142-2 have an equal circumferential pitch, different pitch circle diameters, and a different number of teeth from each other. The first nut pulley teeth 143-1 and the second nut pulley teeth 143-2 have an equal circumferential pitch, an equal pitch circle diameter, and a different number of teeth.

The first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may determine the linear position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

That is, like the above-mentioned determination method, the difference between the reference position value and the operating position value may be set to 0° to 360°, and the maximum slidable amount of the rack bar 130 is set within this range. The electronic control device 110 determines the sliding position of the rack bar 130 on the basis of at least one of a pitch circle diameter ratio or a tooth number ratio between the first motor pulley 142a and the first nut pulley 143a, a pitch circle diameter ratio or a tooth number ratio between the second motor pulley 142b and the second nut pulley 143b, the outer and inner diameters of the ball nut 141, or the outer diameter of the rack bar 130.

In addition, like the above-mentioned determination method, the electronic control device 110 may determine the sliding position of the rack bar 130 by setting the difference between the reference position value and the operating position value to the movement value and comparing the movement value with preset data. In this case, the movement value may be set to 0° to 360°, and the maximum slidable amount of the rack bar 130 is set within this range.

In this case, the preset data may be data including the sliding amount of the rack bar 130 corresponding to the movement value determined based on at least one of the pitch circle diameters and the number of teeth of the first and second motor pulleys 142a and 142b, the pitch circle diameters and the number of teeth of the first and second nut pulleys 143a and 143b, the outer and inner diameters of the ball nut 141, and/or the outer diameter of the rack bar 130.

As described above, the number of the first motor pulley teeth 142-1 and the number of the second motor pulley teeth 142-2 are different, and the number of the first nut pulley teeth 143-1 and the number of the second nut pulley teeth 143-2 are equal. The electronic control device 110 may output a signal for controlling the first motor 145 and the second motor 147 by determining the sliding position of the rack bar 130 on the basis of the first position of the shaft 145a of the first motor 145 sensed by the first motor sensor 145s and the second position of the shaft 147a of the second motor 147 detected by the second motor sensor 147s.

In addition, the number of the first motor pulley teeth 142-1 and the number of the second motor pulley teeth 142-2 may be equal, and the number of the first nut pulley teeth 143-1 and the number of the second nut pulley teeth 143-2 may be different.

The first motor pulley teeth 142-1 and the second motor pulley teeth 142-2 have an equal circumferential pitch and an equal pitch circle diameter, and the same number of teeth. The first nut pulley teeth 143-1 and the second nut pulley teeth 143-2 have an equal circumferential pitch, and different pitch circle diameters and the different number of teeth.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the sliding position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

In addition, the number of the first motor pulley teeth 142-1 and the number of the second motor pulley teeth 142-2 may be different, and the number of the first nut pulley teeth 143-1 and the number of the second nut pulley teeth 143-2 may be different.

That is, the first motor pulley teeth 142-1 and the second motor pulley teeth 142-2 may have an equal circumferential pitch and different pitch circle diameters, and different number of teeth. The first nut pulley teeth 143-1 and the second nut pulley teeth 143-2 have an equal circumferential pitch, different pitch circle diameters, and different number of teeth.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the sliding position of the rack bar 130 through the above-mentioned determination process based on the first position of the shaft 145a of the first motor 145 detected by the first motor sensor 145s and the second position of the shaft 147a of the second motor 147 the second motor sensor 147s.

In an exemplary embodiment of FIG. 8, in order to prepare for a case in which any one of the first motor sensor 145s and the second motor sensor 147s is inoperable, a rotary gear 139, rotatably engaged with a rack gear 130b provided on the rack bar 130, may be rotatably coupled to the rack bar 130, and a rotation angle sensor 137s may be configured to detect a rotation angle of the rotary gear 139.

The rotary gear 139 may be configured to be rotatable while being supported on a rack housing by means of a bearing. The rotation angle sensor 137s may be installed on or around a shaft 137 of the rotary gear 139 and configured to detect a rotation angle of the rotary gear 139 and transmit the rotation angle of the rotary gear 139 to the electronic control device 110.

Therefore, even when any one of the first motor sensor 145s and the second motor sensor 147s is inoperable, the electronic control device 110 may output a signal for controlling the first motor 145 and the second motor 147 by determining the sliding position of the rack bar 130 based on the pre-stored gear ratio between the rack gear 130b and the rotary gear 139 and the rotation angle of the rotary gear 139 received from the rotation angle sensor 137s.

Meanwhile, hereinafter, various embodiments of a rotation prevention member or means may be provided in the above-mentioned steering apparatus.

Some embodiments of the rotation prevention member 150 will be described below more specifically with reference to FIGS. 9 to 18.

As illustrated in FIG. 9, the rotation prevention member 150 may be coupled to one radial side and the other radial side of the rack bar 130 and support two opposite sides of the rack bar 130, thereby preventing the rack bar 130 from rotating.

The rotation prevention member 150 may include a shaft 230 configured to support a support surface 130-1 formed on the outer peripheral surface of the rack bar 130, and a support yoke 240 configured to support the outer peripheral surface of the rack bar 130 opposite or corresponding to a position at which the shaft 230 is supported.

The support surface 130-1 formed on the outer peripheral surface of the rack bar 130 may be formed by machining or grinding the outer peripheral surface of the rack bar 130.

The support surface 130-1 may be recessed from the outer peripheral surface of the rack bar 130 and formed as a curved surface, a flat surface, or combination thereof.

The support surface 130-1 extends in an axial direction of the rack bar 130 so as to be supported by the shaft 230 when the rack bar 130 slides in the axial direction of the rack bar 130.

Optionally, a coating layer may be provided on the support surface 130-1 and made of a low-friction material having a low frictional coefficient, such as fluorine resin or ceramic, in order to minimize or reduce friction with the shaft 230.

The shaft 230, which supports the support surface 130-1 of the rack bar 130, may include an upper end support portion 231, a body portion 233, and a lower end support portion 235.

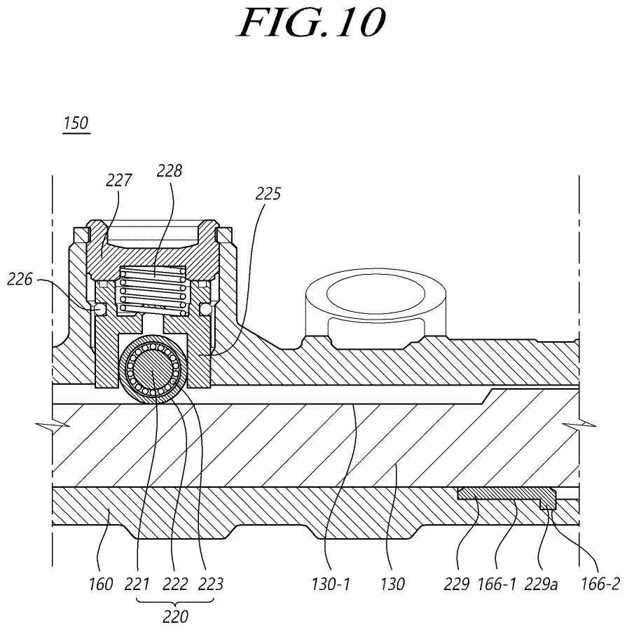

When the rack bar 130 slides, the shaft 230 is supported by a rack housing (e.g., 160 of FIG. 10) and is configured to be rotatable such that the body portion 233 supports the support surface 130-1 of the rack bar 130, thereby preventing the rack bar 130 from rotating.

A needle bearing 236 may be coupled to the body portion 233 to minimize or reduce friction with the support surface 130-1 of the rack bar 130.

The upper end support portion 231, which has a larger diameter than the body portion 233, may be provided above the body portion 233, and an upper end bearing 234 may be coupled to the upper end support portion 231 so as to be rotatably supported on the rack housing.

A top plug 232 may be coupled to an upper side of the upper end support portion 231 in order to prevent foreign substances from being introduced into the rack housing.

The lower end support portion 235, which has a smaller diameter than the body portion 233, may be provided below the body portion 233, and a lower end bearing 238 may be coupled to the lower end support portion 235 so as to be rotatably supported on the rack housing.

The support yoke 240, which supports the outer peripheral surface of the rack bar 130 opposite to a position at which the shaft 230 is supported, supports the rack bar 130 toward the shaft 230 when the rack bar 130 slides, thereby preventing the rack bar 130 from rotating.

A curved surface support portion 241 may be formed at an end portion of the support yoke 240 and may be supported on and closely contacted with the outer peripheral surface of the rack bar 130. The curved surface support portion 241 may have a curved surface identical to the outer peripheral surface of the rack bar 130.

The support yoke 240 may have predetermined rigidity and elasticity and may be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

An elastic ring 245 may be coupled to an outer peripheral surface of the support yoke 240 to prevent rattle noise with the rack housing.

One or more elastic rings 245 may be coupled to the outer peripheral surface of the support yoke 240.

The elastic ring 245 may be made of a material capable of absorbing vibration and noise and having predetermined elasticity and rigidity. For instance, the elastic ring 245 may be made of one or more materials selected from a group consisting of natural rubber (NR), nitrile butadiene rubber (NBR), chloroprene rubber (CR), ethylene propylene terpolymer (EPDM), fluoro-rubber (FPM), styrene butadiene rubber (SBR), chlorosulfonated polyethylene (CSM), urethane, and silicone that have the above-mentioned properties.

A yoke plug 243 may be coupled to an end portion of the support yoke 240, press-fitted or screw-coupled to the rack housing, and fix the support yoke 240.

Further, an elastic body may be coupled between the support yoke 240 and the yoke plug 243 and elastically support the support yoke 240 toward the rack bar 130.

As illustrated in FIG. 10, the rotation prevention member 150 may be coupled to one radial side and the other radial side of the rack bar 130 and support two opposite sides of the rack bar 130, thereby preventing the rack bar 130 from rotating.

The rotation prevention member 150 may include a needle bearing 220 configured to support the support surface 130-1 formed on the outer peripheral surface of the rack bar 130, a support yoke 225 rotatably coupled to the needle bearing 220, and a rack bushing 229 configured to support the outer peripheral surface of the rack bar 130 opposite to a position at which the needle bearing 220 is supported.

The support surface 130-1 may be formed on the outer peripheral surface of the rack bar 130. For instance, the support surface 130-1 may be formed by machining or grinding the outer peripheral surface of the rack bar 130.

The support surface 130-1 may be recessed from the outer peripheral surface of the rack bar 130. The support surface 130-1 may be formed as a curved surface or a flat surface.

The support surface 130-1 is elongated in the axial direction of the rack bar 130. And, the support surface 130-1 may be supported by the needle bearing 220 when the rack bar 130 slides in the axial direction of the rack bar 130.

A coating layer may be provided on the support surface 130-1 and made of a low-friction material, such as fluorine resin or ceramic, in order to minimize or reduce friction with the needle bearing 220.

The needle bearing 220 may be configured to support the support surface 130-1 of the rack bar 130, the needle bearing 220 may have a support shaft 221 provided at a central portion of the needle bearing 220, and the support shaft 221 is fixed to the support yoke 225 so that the needle bearing 220 may be rotatably supported by the support yoke 225.

An outer race 222 of the needle bearing 220 is supported on the support surface 130-1 and is configured to rotate when the rack bar 130 slides in order to prevent the rack bar 130 from rotating.

The outer race 222 of the needle bearing 220 may be disposed at a position protruding from an end portion of the support yoke 225 so that the outer race 222 may be supported on the support surface 130-1.

The support yoke 225 supports the needle bearing 220 toward the support surface 130-1 when the rack bar 130 slides in order to prevent the rotation of the rack bar 130.

The support yoke 225 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

An elastic ring 226 may be coupled to the outer peripheral surface of the support yoke 225 to prevent rattle noise with the rack housing 160.

One or more elastic rings 226 may be coupled to the outer peripheral surface of the support yoke 225.

The elastic ring 226 may be made of a material capable of absorbing vibration and noise and having predetermined elasticity and rigidity. Therefore, the elastic ring 226 may be made of one or more materials selected from a group consisting of natural rubber (NR), nitrile butadiene rubber (NBR), chloroprene rubber (CR), ethylene propylene terpolymer (EPDM), fluoro-rubber (FPM), styrene butadiene rubber (SBR), chlorosulfonated polyethylene (CSM), urethane, and silicone that have the above-mentioned properties.

A yoke plug 227 may be coupled to an end of the support yoke 225, press-fitted or screw-coupled to the rack housing 160, and configured to fix the position of the support yoke 225.

Further, an elastic body 228 may be coupled between the support yoke 225 and the yoke plug 227 and elastically support the support yoke 225 by applying an elastic force toward the rack bar 130.

The rack bushing 229, which supports the outer peripheral surface of the rack bar 130 opposite to another outer peripheral surface of the rack bar 130 which the needle bearing 220 supports, may be formed in a semi-cylindrical shape made by cutting a part of an outer peripheral surface thereof.

The rack bushing 229 supports the rack bar 130 toward the needle bearing 220 in the radial direction of the rack bushing 229 when the rack bar 130 slides, thereby preventing the rack bar 130 from rotating.

The rack bushing 229 may have a curved surface identical to or corresponding to the outer peripheral surface of the rack bar 130 so as to be closely contacted with and supported on the outer peripheral surface of the rack bar 130.

A bushing coupling groove 166-1, to which the rack bushing 229 is coupled, may be formed on an inner peripheral surface of the rack housing 160.

The rack bushing 229 may have a fixing protrusion 229a formed on or around an end portion of an outer peripheral surface of the rack bushing 229 in order to prevent the axial position of the rack bushing 229 from being separated or rotated when the rack bar 130 slides.

A fixing groove 166-2 may be formed on the inner peripheral surface of the rack housing 160, and the fixing protrusion 229a of the rack bushing 229 may be coupled to the fixing groove 166-2 of the rack housing 160.

The rack bushing 229 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

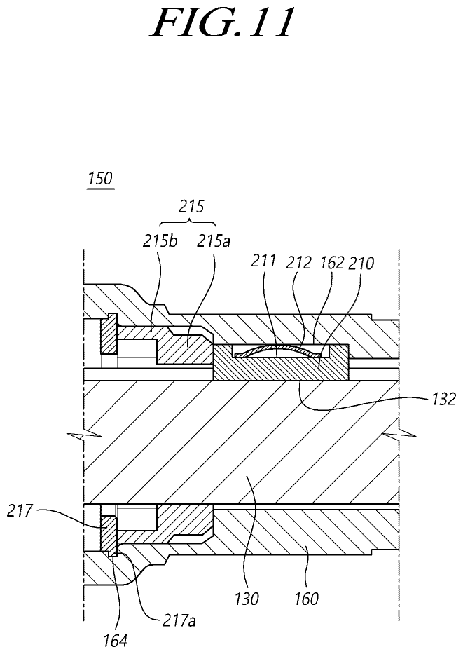

In an embodiment illustrated in FIG. 11, the rotation prevention member 150 may be configured to prevent the rack bar 130 from rotating about the central axis of the rack bar 130. The rotation prevention member 150 supports the outer peripheral surface of the rack bar 130 and may be supported on the inner peripheral surface of the rack housing 160.

The rotation prevention member 150 may include a support member 210 having one end portion disposed or supported in a rack support groove 132 formed on the outer peripheral surface of the rack bar 130, and the other end portion disposed or supported in a housing groove 162 formed on the inner peripheral surface of the rack housing 160, and an elastic member 212 coupled to the support member 210 and configured to elastically support the inner peripheral surface of the rack housing 160.

The rack support groove 132 formed on the outer peripheral surface of the rack bar 130 may be formed by machining or grinding the outer peripheral surface of the rack bar 130.

The rack support groove 132 may be recessed from the outer peripheral surface of the rack bar 130. The rack support groove 132 may have a curved surface or a flat surface.

The rack support groove 132 may be elongated in the axial direction of the rack bar 130 and be supported by the support member 210 when the rack bar 130 slides in the axial direction of the rack bar 130.

A coating layer may be provided on the rack support groove 132 and made of a low-friction material, such as fluorine resin or ceramic, in order to reduce or minimize friction with the support member 210.

The housing groove 162, in which the other end portion of the support member 210 is supported, may be formed at a position facing the rack support groove 132 in the radial direction of the rack bar 130.

For example, the housing groove 162 may be formed by machining or grinding the inner peripheral surface of the rack housing 160.

The housing groove 162 may be recessed from the inner peripheral surface of the rack housing 160 and have a curved surface or a flat surface so that the support member 210 can prevents the rotation of the rack bar 130 when the rack bar 130 slides in the axial direction of the rack bar 130.

One end portion and the other end portion of the support member 210 are coupled to the rack support groove 132 and the housing groove 162, respectively, and a coupling groove 211, to which the elastic member 212 is coupled, is formed at the other end portion of the support member 210.

The support member 210 may have predetermined rigidity and elasticity and be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

The elastic member 212 is coupled to the coupling groove 211 of the support member 210, supports the support member 210 and is configured to apply elastic force toward the rack bar 130 while being elastically supported on the inner peripheral surface of the rack housing 160, such that the support member 210 maintains a predetermined interval so as not to collide with the inner peripheral surface of the rack housing 160 when the rack bar 130 slides in the axial direction of the rack bar 130. Therefore, rattle noise between the support member 210 and the rack housing 160 may be prevented.

For example, the elastic member 212 may be formed as an arcuate thin board.

A plug bolt 215 may be disposed at an axial end of the support member 210, may be configured to prevent the separation of the support member 210, and may be coupled to the inner peripheral surface of the rack housing 160. For instance, the plug bolt 215 may be press-fitted and coupled to the inner peripheral surface of the rack housing 160.

The plug bolt 215 includes a support portion 215a configured to support the support member 210 in the axial direction of the rack bar 130, and a fixing portion 215b extended from the support portion 215a and fixed to the inner peripheral surface of the rack housing 160.

The outer peripheral surface of the fixing portion 215b has a threaded portion screw-coupled to the inner peripheral surface of the rack housing 160.

Further, a fixing member 217 may be coupled to an axial end of the plug bolt 215 in order to prevent the plug bolt 215 from being loosened and separated.

A fixing protrusion 217a protruding in the radial direction of the rack housing 160 may project from an outer peripheral surface of the fixing member 217.

A fixing groove 164 may be formed on the inner peripheral surface of the rack housing 160, and the fixing protrusion 217a of the fixing member 217 may be inserted into and supported by the fixing groove 164.

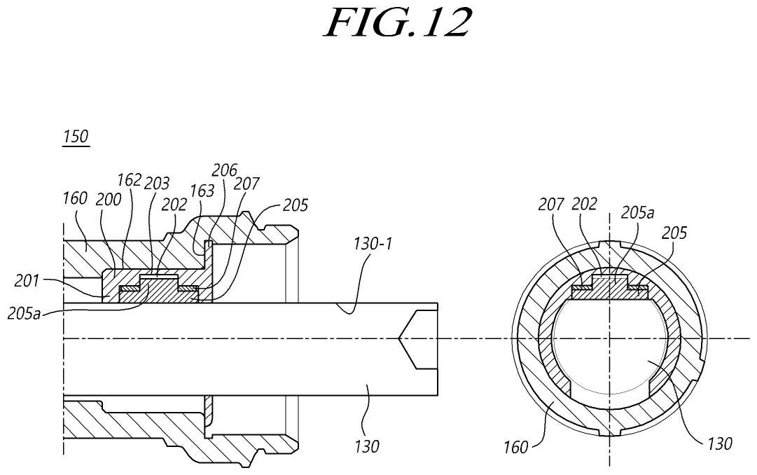

In an embodiment of FIG. 12, the rotation prevention member 150 may be supported on the outer peripheral surface of the rack bar 130 and the inner peripheral surface of the rack housing and prevent the rack bar 130 from rotating about the central axis.

The rotation prevention member 150 may include a support bushing 205 configured to support the support surface 130-1 formed on the outer peripheral surface of the rack bar 130, a bushing holder 200 coupled to the outer peripheral surface of the rack bar 130 and having an inner peripheral surface on which the support bushing 205 is supported, and an elastic member 207 coupled between the bushing holder 200 and the support bushing 205 and configured to elastically support the support bushing 205 by apply elastic force toward the rack bar 130.

For example, the support surface 130-1 formed on the outer peripheral surface of the rack bar 130 may be formed by machining or grinding the outer peripheral surface of the rack bar 130.

The support surface 130-1 may be recessed from the outer peripheral surface of the rack bar 130 and may have a curved surface or a flat surface.

The support surface 130-1 is elongated in the axial direction of the rack bar 130 and is supported by the support bushing 205 when the rack bar 130 slides in the axial direction.

A coating layer may be provided on the support surface 130-1 and made of a low-friction material, such as fluorine resin or ceramic, in order to minimize or reduce friction with the support bushing 205.

The housing groove 162, to and in which the bushing holder 200 is coupled and

supported, is formed on the inner peripheral surface of the rack housing 160, and is positioned to face the support surface 130-1 in the radial direction of the rack bar 130.

For example, the housing groove 162 may be formed by machining or grinding the inner peripheral surface of the rack housing 160.

The housing groove 162 may be recessed from the inner peripheral surface of the rack housing 160 and may have a curved surface or a flat surface.

In addition, a stepped projection portion 163 having a larger diameter at an end portion of the housing groove 162 may be formed on the inner peripheral surface of the rack housing 160, and an end portion of the stepped projection portion 163 may have an opening in the axial direction of the rack bar 130.

The bushing holder 200 has a cylindrical shape. For instance, the bushing holder 200 may have a cut-out portion made by cutting one radial side of the bushing holder 200, and an inner peripheral protruding surface 201 which protrudes radially inward.

Further, a bushing coupling groove 203, to which the support bushing 205 is coupled, may be formed on the inner peripheral protruding surface 201. A flange portion 206 protrudes in the radial direction, is supported by or on the stepped projection portion 163 of the rack housing 160, and may be formed at an axial end of the bushing holder 200.

The flange portion 206 is supported by or on the stepped projection portion 163 to prevent the separation of the bushing holder 200 when the rack bar 130 slides in the axial direction.

The support bushing 205 coupled to the bushing coupling groove 203 of the bushing holder 200 includes a protruding support portion 205a protruding from a central portion of the support bushing 205, and the elastic member 207 is coupled to the protruding support portion 205a.

For example, the elastic member 207 may be formed in an annular shape and formed in a cone shape in which an inner peripheral surface and an outer peripheral surface of the elastic member 207 are stepped in the axial direction such that the protruding support portion 205a may be coupled to an inner peripheral surface of the elastic member 207.

The elastic member 207 elastically supports the support bushing 205 to apply elastic force toward the rack bar 130 and the elastic member 207 may be positioned between the bushing holder 200 and the support bushing 205, thereby forming a gap or space 202 so that the support bushing 205 cannot collide with the bushing holder 200 when the rack bar 130 slides in the axial direction to prevent or reduce rattle noise between the support bushing 205 and the bushing holder 200.

The bushing holder 200 and the support bushing 205 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

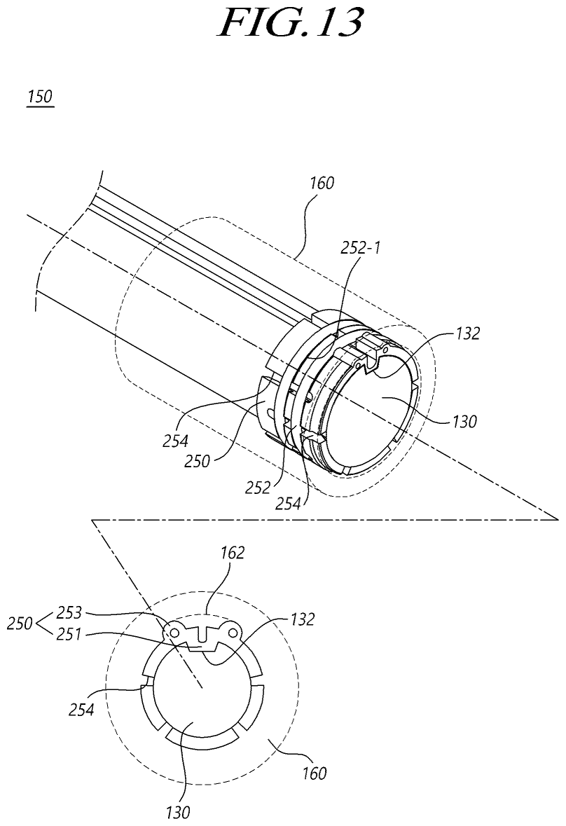

In an embodiment of FIG. 13, the rotation prevention member 150 may support the outer peripheral surface of the rack bar 130 to prevent the rack bar 130 from rotating about the central axis of the rotation prevention member 150 and may be supported by the inner peripheral surface of the rack housing 160.

The rotation prevention member 150 may include a rack bushing 250 having an inner peripheral support portion 251 inserted in and supported by the rack support groove 132 formed on the outer peripheral surface of the rack bar 130 and an outer peripheral support portion 253 inserted in and supported by the housing groove 162 formed on the inner peripheral surface of the rack housing 160, and an elastic member 252 coupled to the outer peripheral surface of the rack bushing 250 and configured to elastically support the rack bushing 250.

For example, the rack support groove 132 formed on the outer peripheral surface of the rack bar 130 may be formed by machining or grinding the outer peripheral surface of the rack bar 130.

The rack support groove 132 may be recessed from the outer peripheral surface of the rack bar 130 and may have a curved surface or a flat surface.

The rack support groove 132 is elongated in the axial direction of the rack bar 130 so as to be supported by the rack bushing 250 when the rack bar 130 slides in the axial direction.

A coating layer may be provided on the rack support groove 132 and made of a low-friction material, such as fluorine resin or ceramic, in order to minimize or reduce friction with the rack bushing 250.

The inner peripheral support portion 251 protrudes radially inward from the inner peripheral surface of the rack bushing 250 at a position facing the rack support groove 132.

The outer peripheral support portion 253 protrudes radially outward from the outer peripheral surface of the rack bushing 250 and is coupled to the housing groove 162.

For instance, the housing groove 162 may be formed by machining or grinding the inner peripheral surface of the rack housing 160.

The housing groove 162 may be recessed from the inner peripheral surface of the rack housing 160 and may have a curved surface or a flat surface.

Two or more outer peripheral support portions 253 may be formed on the outer peripheral surface of the rack bushing 250 and spaced apart from one another in a circumferential direction.

For instance, a pair of outer peripheral support portions 253 may be formed on the outer peripheral surface of the rack bushing 250 in the circumferential direction at a position corresponding to the inner peripheral support portion 251.

The rack bushing 250 may have predetermined rigidity and elasticity and be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

The elastic member 252 may be coupled to the outer peripheral surface of the rack bushing 250 and have a ring shape.

The elastic member 252 may be made of a material capable of absorbing vibration and

noise and have predetermined elasticity and rigidity. Therefore, the elastic member 252 may be made of one or more materials selected from a group consisting of natural rubber (NR), nitrile butadiene rubber (NBR), chloroprene rubber (CR), ethylene propylene terpolymer (EPDM), fluoro-rubber (FPM), styrene butadiene rubber (SBR), chlorosulfonated polyethylene (CSM), urethane, and silicone that have the above-mentioned properties.

A coupling groove 252-1, to which the elastic member 252 is coupled, may be formed on the outer peripheral surface of the rack bushing 250.

The rack bushing 250 may have a cut-out portion 254 cut in the axial direction so that the rack bushing 250 is deformable in the radial direction.

Two or more cut-out portions 254 spaced apart from one another in the circumferential direction may be provided.

The cut-out portions 254 may be formed such that one end or the other end of the rack bushing 250 is opened at a position wherein the cut-out portion 254 is formed.

The cut-out portions 254 opened at one end of the rack bushing 250 and the cut-out portion 254 opened at the other end of the rack bushing 250 may be spaced apart from each other in the circumferential direction and formed in a staggered manner.

Therefore, the rack bushing 250 is elastically supported in the radial direction by elastic force of the elastic member 252 so that the rack bushing 250 cannot collide with the rack housing 160 when the rack bar 130 slides in the axial direction to prevent or reduce rattle noise between the rack bushing 250 and the rack housing 160.

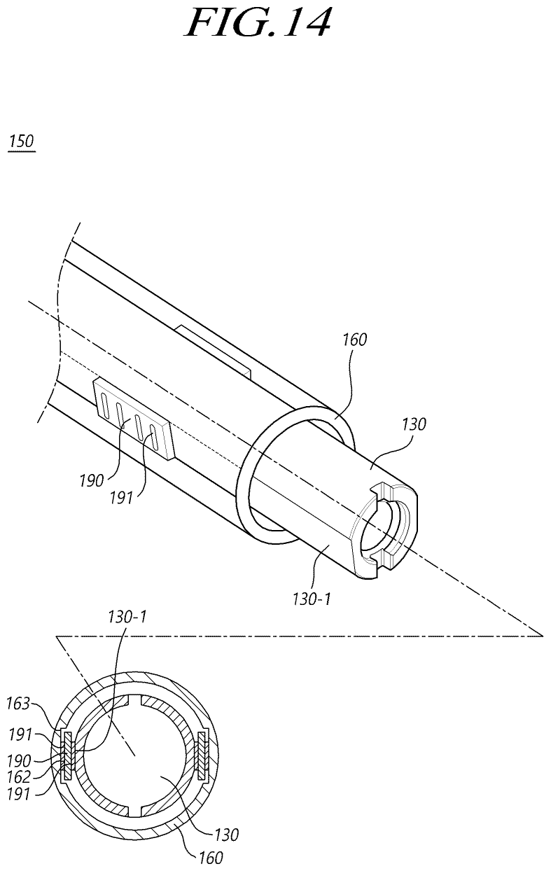

In an embodiment illustrated in FIG. 14, the rotation prevention member 150 may support the outer peripheral surface of the rack bar 130 to prevent the rack bar 130 from rotating about the central axis of the rack bar 130 and may be supported by the inner peripheral surface of the rack housing 160.

The rotation prevention member 150 may include a rotary member 191 configured to support the support surface 130-1 formed on the outer peripheral surface of the rack bar 130, and a support bushing 190 coupled to the housing groove 162 formed on the inner peripheral surface of the rack housing 160 and configured such that the rotary member 191 is rotatably coupled to the support bushing 190.

For instance, the support surface 130-1 formed on the outer peripheral surface of the rack bar 130 may be formed by machining or grinding the outer peripheral surface of the rack bar 130.

The support surface 130-1 may be recessed from the outer peripheral surface of the rack bar 130 and have a curved surface or a flat surface.

The support surface 130-1 is elongated in the axial direction of the rack bar 130 so as to be supported by the rotary member 191 when the rack bar 130 slides in the axial direction.

Two or more support surfaces 130-1 may be formed on the outer peripheral surface of the rack bar 130 and spaced apart from one another in the circumferential direction of the rack bar 130.

For instance, a pair of support surfaces 130-1 may formed at opposite sides of the rack bar 130 with respect to the center of the rack bar 130.

The rotary members 191 may be configured as a roller or ball movably disposed in an inner surface of the support bushing 190 (e.g. within one or more elongated holes of the support bushing 190) and configured to be rotatable or rollable while being supported on the support surface 130-1 of the rack bar 130.

The rotary members 191 may be rotatably supported on both the inner and outer surfaces of the support bushing 190.

A coating layer may be provided on the support surface 130-1 and made of a low-friction material, such as fluorine resin or ceramic, in order to reduce or minimize friction with the rotary member 191.

The housing groove 162, in which the support bushing 190 is disposed, is formed on the inner peripheral surface of the rack housing 160 at a position facing a support surface 130-1 of the rotary member 191 in the radial direction.

The support bushing 190 is coupled to the housing groove 162 of the rack housing 160, and the rotary member 191 is rotatably coupled to the support bushing 190.

The support bushing 190 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

For instance, the housing groove 162 may be formed by machining or grinding the inner peripheral surface of the rack housing 160.

The housing groove 162 may be recessed from the inner peripheral surface of the rack housing 160 and may have a curved surface or a flat surface.

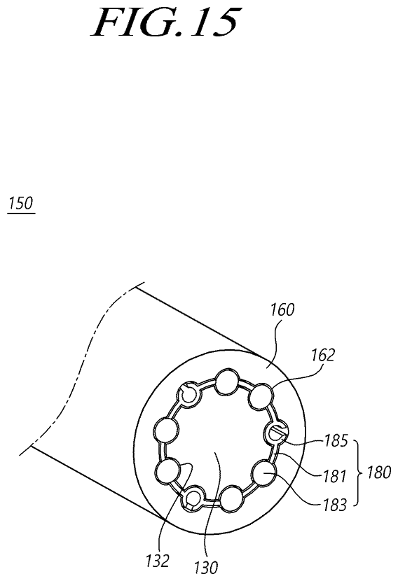

In an embodiment illustrated in FIG. 15, the rotation prevention member 150 may support the outer peripheral surface of the rack bar 130 to prevent the rack bar 130 from rotating about the central axis and is supported by the inner peripheral surface of the rack housing.

The rotation prevention member 150 may include a rack bushing 180 having one or more rotation support portions 183 rotatably disposed between the rack support groove 132 formed on the outer peripheral surface of the rack bar 130 and the housing groove 162 formed on the inner peripheral surface of the rack housing 160, an elastic support portion 185 disposed between and elastically supported by the rack support groove 132 formed on the outer peripheral surface of the rack bar 130 and the housing groove 162 formed on the inner peripheral surface of the rack housing 160, and a connection portion 181 connecting the rotation support portion 183 and the elastic support portion 185.

The rack support groove 132 may be formed on the outer peripheral surface of the rack bar 130. For instance, the rack support groove 132 may be formed by machining or grinding the outer peripheral surface of the rack bar 130.

The rack support groove 132 may be recessed from the outer peripheral surface of the rack bar 130, and include a curved surface or a flat surface.

The rack support groove 132 is elongated in the axial direction of the rack bar 130 and is supported by the rotation support portion 183 and the elastic support portion 185 when the rack bar 130 slides in the axial direction. The rotation support portion 183 and the elastic support portion 185 may be disposed in the rack support groove 132.

The housing groove 162 is formed on the inner peripheral surface of the rack housing 160 at the position facing or corresponding to the rack support groove 132 in the radial direction.

For instance, the housing groove 162 may be formed by machining or grinding the inner peripheral surface of the rack housing 160.

The housing groove 162 may be recessed from the inner peripheral surface of the rack housing 160 and may have a curved surface or a flat surface.

A coating layer may be provided on the rack support groove 132 and the housing groove 162 and made of a low-friction material, such as fluorine resin or ceramic, in order to minimize or reduce friction with the rack bushing 180.

The rack bushing 180 may have two or more rotation support portions 183 and/or two or more elastic support portions 185.

Balls may be coupled to the rotation support portions 183, and the balls may be spaced apart from one another in the axial direction.

The elastic support portion 185 may have a substantially cylindrical shape. The elastic support portion 185 may have an opening at one side thereof.

The rack bushing 180 is elastically supported by the rack support groove 132 and the housing groove 162 by an elastic deformation force of the elastic support portion 185, thereby maintaining a predetermined interval so that the rack bushing 180 does not collide with the rack housing 160 when the rack bar 130 slides in the axial direction to prevent rattle noise between the rack bushing 180 and the rack housing 160.

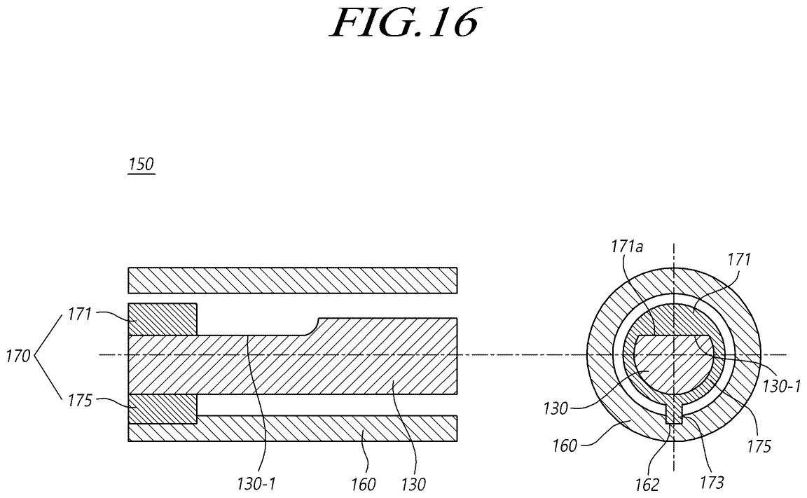

In an embodiment illustrated in FIG. 16, the rotation prevention member 150 may support the outer peripheral surface of the rack bar 130 to prevent the rack bar 130 from rotating about the central axis and the rotation prevention member 150 may be supported by the inner peripheral surface of the rack housing 160.

The rotation prevention member 150 may include a rack bushing 170 having a first support portion 171 and a second support portion 175. The first support portion 171 may be configured to support the support surface 130-1 formed on the outer peripheral surface of the rack bar 130. The second support portion 175 may be extended from or connected to the first support portion 171, may be configured to support the outer peripheral surface of the rack bar 130, and may have an outer peripheral surface on which a fixing protrusion 173, which is coupled to the housing groove 162 formed on the inner peripheral surface of the rack housing 160.

For example, the support surface 130-1 formed on a part of the outer peripheral surface of the rack bar 130 may be formed by machining or grinding the outer peripheral surface of the rack bar 130.

The support surface 130-1 may be recessed from the outer peripheral surface of the rack bar 130 and may have a curved surface or a flat surface.

The support surface 130-1 is elongated in the axial direction of the rack bar 130 so as to be supported by the first support portion 171 when the rack bar 130 slides in the axial direction.

An inner peripheral surface 171a of the first support portion 171 may be closely contacted with and supported by the support surface 130-1 of the rack bar 130, and an outer peripheral surface of the first support portion 171 may be spaced apart from the inner peripheral surface of the rack housing 160.

A coating layer may be provided on the support surface 130-1 and the outer peripheral surface of the rack bar 130 and made of a low-friction material, such as fluorine resin or ceramic, in order to minimize or reduce friction with the rack bushing 170.

The second support portion 175 is extended from or connected to the first support portion 171 in the circumferential direction and surrounds the outer peripheral surface of the rack bar 130.

The fixing protrusion 173 protrudes from the outer peripheral surface of the second support portion 175 in the radial direction.

The housing groove 162 may be formed on the inner peripheral surface of the rack housing 160, and the fixing protrusion 173 of the second support portion 175 may be inserted in or coupled to the housing groove 162, thereby preventing the rack bushing 170 from rotating.

For example, the housing groove 162 may be formed by machining or grinding the inner peripheral surface of the rack housing 160.

The housing groove 162 may be recessed from the inner peripheral surface of the rack housing 160 and may have a curved surface or a flat surface.

The rack bushing 170 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

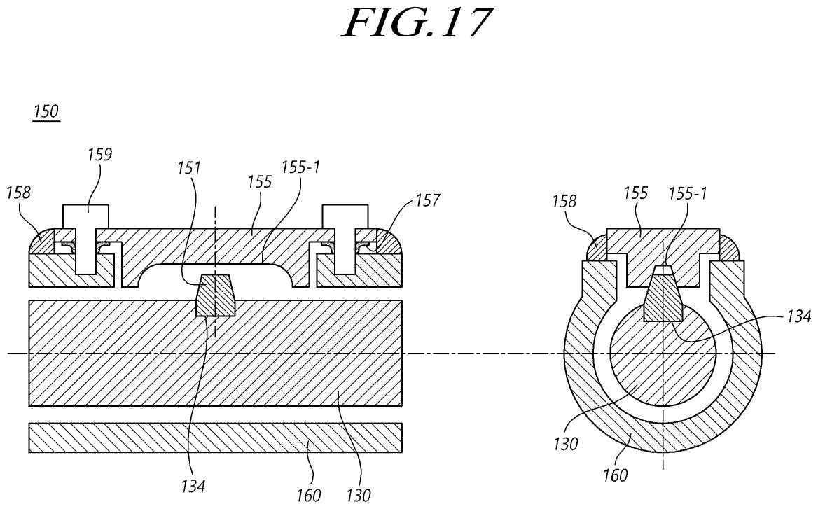

In an embodiment illustrated in FIG. 17, the rotation prevention member 150 may be supported by a guide cover 155, which is coupled to the rack housing 160, and may support the outer peripheral surface of the rack bar 130 to prevent the rack bar 130 from rotating about the central axis.

The rotation prevention member 150 may include a support member 151 coupled to the outer peripheral surface of the rack bar 130, the guide cover 155 coupled to the rack housing 160 and having an inner peripheral surface which the support member 151 supports, and a fastener 159 configured to fix the guide cover 155 to the rack housing 160.

The support member 151 may be coupled to the outer peripheral surface of the rack bar 130. For instance, the support member 151 may be coupled, by press-fitting, bonding, or the like, to a coupling groove 134 formed on the outer peripheral surface of the rack bar 130. The coupling groove 134 may be formed by machining or grinding the outer peripheral surface of the rack bar 130.

The coupling groove 134 may be recessed from the outer peripheral surface of the rack bar 130 and may have a curved surface or a flat surface.

The rack housing 160 may have an opening at a position facing or corresponding to the support member 151, and the guide cover 155 is coupled to and covers the opening of the rack housing 160.

The inner peripheral surface of the guide cover 155 may have a support groove 155-1 into and by which the support member 151 is inserted and supported.

The support groove 155-1 of the guide cover 155 is elongated in the axial direction of the rack bar 130 so that the support member 151 may be supported by the support groove 155-1 when the rack bar 130 slides in the axial direction.

The support groove 155-1 may have, for example, but not limited to, a trapezoidal shape having a width that increases toward the support member 151.

The support member 151 may have a trapezoidal shape having a width that decreases from the outer peripheral surface of the rack bar 130 toward the support groove 155-1.

Two opposite side surfaces of the support groove 155-1 may be closely contacted with and supported by the support member 151, and an inner top surface of the support groove 155-1 positioned between the two opposite side surfaces of the support groove 155-1 may be spaced apart from an end of the support member 151.

A coating layer may be provided on the support groove 155-1 or the support member 151 and made of a low-friction material, such as fluorine resin or ceramic, in order to reduce or minimize friction.

The support groove 155-1 may have grease therein in order to minimize friction with the support member 151.

The guide cover 155 may be fixed to the rack housing 160 by the fastener 159.

Further, an elastic member 157 may be disposed between the guide cover 155 and the rack housing 160, penetrated by the fastener 159, and configured to elastically support the guide cover 155 and the rack housing 160.

A sealing member or seal 158 may be applied onto the ends of the guide cover 155 and the outer peripheral surface of the rack housing 160 in order to prevent moisture or dust from being introduced from the outside of the rack housing 160.

The support member 151 and the guide cover 155 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

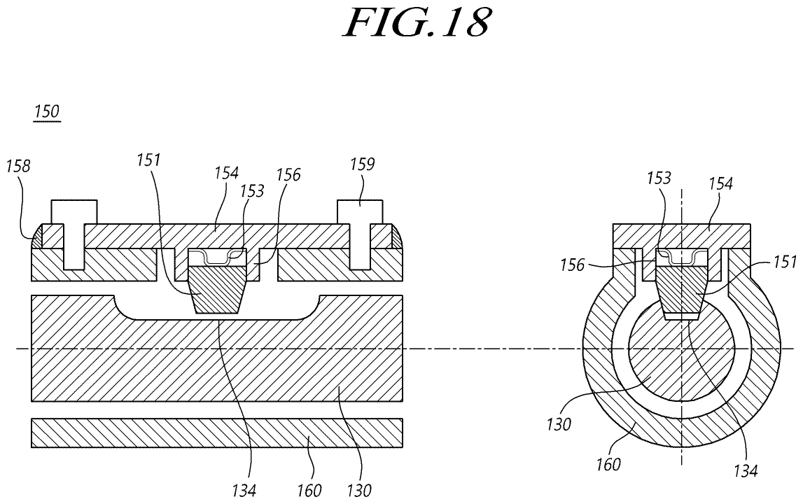

In an embodiment illustrated in FIG. 18, the rotation prevention member 150 may be supported by a housing cover 154, which is coupled to the rack housing 160, and the outer peripheral surface of the rack bar 130, thereby preventing the rack bar 130 from rotating about the central axis of the rack bar 130.

The rotation prevention member 150 may include the support member 151 supporting the outer peripheral surface of the rack bar 130, the housing cover 154 fixed to the rack housing 160 and having the inner peripheral surface to which the support member 151 is coupled, and the fastener 159 configured to fix the housing cover 154 to the rack housing 160.

A rack support groove 134 by which the support member 151 is supported is formed on the outer peripheral surface of the rack bar 130.

The rack support groove 134 is elongated or extended in the axial direction of the rack bar 130 so that the support member 151 may be supported by the rack support groove 134 when the rack bar 130 slides in the axial direction.

The rack support groove 134 may be recessed from the outer peripheral surface of the rack bar 130 and may have a curved surface or a flat surface.

The rack housing 160 may have an opening a position corresponding to or facing the rack support groove 134, and the housing cover 154 is coupled to the opening of the rack housing 160.

A cover support groove 156, in which the support member 151 is positioned, may be formed on the inner peripheral surface of the housing cover 154.

The rack support groove 134 may have, for example, but not limited to, a trapezoidal shape with a width that increases toward the housing cover 154.

The support member 151 may have a trapezoidal shape with a width that decreases from the cover support groove 156 toward the rack support groove 134.

Two opposite side surfaces of the rack support groove 134 may be closely contacted with and supported by the support member 151, and an inner surface of the rack support groove 134 positioned between the two opposite side surfaces of the rack support groove 134 may be spaced apart from the end of the support member 151.

A coating layer may be provided on the rack support groove 134 or the support member 151 and made of a low-friction material, such as fluorine resin or ceramic, in order to reduce or minimize friction.

The rack support groove 134 may be provided or filled with grease in order to reduce or minimize friction with the support member 151.

The housing cover 154 may be fixed to the rack housing 160 by the fastener 159.

The seal or sealing member 158 may be applied onto the end portion of the housing cover 154 and the outer peripheral surface of the rack housing 160 in order to prevent moisture or dust from being introduced from the outside of the rack housing 160.

The support member 151 and the housing cover 154 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

As described above, a steer-by-wire steering apparatus according to some embodiments of the present disclosure may have the plurality of motors and provide a steering force to a rack bar. In addition, a steer-by-wire steering apparatus according to some embodiments of the present disclosure may prevent unnecessary rotation of a rack bar even though means for preventing the rotation of the rack bar is provided and the pinion is excluded.

Hereinafter, various embodiments related to a method of determining the position of a rack bar in a steer-by-wire steering apparatus will be described. Some embodiments of the method of determining the position of the rack bar described below may be applied regardless of the above-mentioned configuration, position and shape of the motor. However, certain embodiments of the method of determining the position of the rack bar may be applied to the above-mentioned configuration, position and shape of the motor. In addition, the method of determining the position of the rack bar may be applied in exemplary embodiments of the steer-by-wire steering apparatus not including the rotation prevention member or may be applied in any type of a rotation prevention member.

In the steer-by-wire steering apparatus, the electronic control device 110 may control the operations of one or more drive motors (e.g., 145 and 147). For instance, the electronic control device 110 may receive information or one or more signals from one or more sensors associated with the vehicle and control one or more drive motors based on the information or signals received from one or more sensors.

One or more sensors include various sensors, such as a steering angle sensor, a steering torque sensor, a vehicle speed sensor, a rack position sensor, and any type of a sensor mounted to or provided in the vehicle in association with the steering of the vehicle. However, as described above, according to some embodiments of the present disclosure, the pinion may not be included in the steer-by-wire steering apparatus in case that the rack bar is configured to be moved by the first motor and the second motor. In this case, the rack position sensor configured to detect an absolute position of the rack bar may not be included in the steer-by-wire steering apparatus. Alternatively, the rack position sensor configured to detect the absolute position of the rack bar may be included in a gearbox configured to connect the first and/or second motors to the rack bar.

First, various embodiments for identifying the absolute position (or an absolute angle) of the rack bar will be described. Thereafter, an embodiment comprising an absolute angle sensor configured to detect the absolute position (or an absolute angle) of the rack bar will be described.

The electronic control device 110 may control an operation of the steering shaft motor 120. The electronic control device 110 may be configured as one chip integrated physically. Alternatively, the electronic control device 110 may be configured by a plurality of chips. For instance, each of a reaction force motor, a drive motor, a main control unit, and any component of the steer-by-wire steering apparatus includes one or more chips to perform their necessary operations.

Meanwhile, the electronic control device 110 may control a traveling direction of the vehicle in accordance with the driver's steering intention by controlling the operations of the plurality of drive motors (e.g., 145 and 147).

Multiple electronic control devices 110 may be provided in the steer-by-wire steering apparatus in order to ensure redundancy and constantly or stably perform the same operation even in a case that any one of the plurality of the electronic control devices 110 is abnormal or inoperable. Alternatively, the multiple electronic control devices 110 includes a main electronic control device and a sub-electronic control device. The main electronic control device may control the operation of the steer-by-wire steering apparatus if the main electronic control device is in a normal state, and the sub-electronic control device may control the operation of the steer-by-wire steering apparatus if the main electronic control device is abnormal or inoperable.

The electronic control device 110 may control the steering of the vehicle in response to various information. The steer-by-wire (SBW) system may need accurate information regarding a position of the rack bar to accurately control the steering of the vehicle especially in case that the plurality of motors is used to control the rack bar.

To this end, the electronic control device 110 may receive the position information of the rack bar from the rack position sensor. Alternatively, the electronic control device 110 may estimate the position of the rack bar by using positions of the plurality of motors without the rack position sensor.

For example, the electronic control device 110 may receive rotation information of each of the motors from the plurality of motor position sensors. In an exemplary embodiment of the present disclosure, the rotation information of the motor may include rotation information of the first motor and rotation information of the second motor. The rotation information of the first motor may be received from a first motor position sensor included in or associated with the first motor. The rotation information of the second motor may be received from a second motor position sensor included in or associated with the second motor.

The motor position sensor may detect rotation information of each of the motors. The motor position sensor may detect a rotation of a motor shaft. Alternatively, the motor position sensor may detect a rotation of any rotatable component or structure connected to or associated with the motor shaft. The motor position sensor may detect a rotary position between 0 degree and 360 degrees related to the rotation of the motor. For instance, the motor position sensor may measure a rotation angle and/or a position of the motor.

For example, the motor position sensor may be an optical sensor or encoder configured to detect a position by emitting light to a rotary plate or disk. Alternatively, the motor position sensor may be a magnetic sensor or encoder configured to measure a position of a rotor by detecting a magnetic field. Alternatively, the motor position sensor may be an incremental sensor or encoder configured to measure a change in a relative position of a rotor by outputting a predetermined pulse. Alternatively, the motor position sensor may be an absolute sensor or encoder configured to measure an absolute position of a rotor by outputting a unique value related to a particular position. The motor position sensor according to certain embodiments of the present disclosure may provide a precise position and/or velocity of the motor.

For instance, a Hall sensor, which measures a position of a motor by detecting a change in magnetic flux of a rotor to which a permanent magnet or magnetic material is attached or mounted, may be used as the motor position sensor. The motor of the steer-by-wire steering apparatus may be a Brushless Direct Current (BLDC) motor, and three Hall sensors having a phase difference of 120 degrees or 60 degrees may be arranged or disposed to detect the position of the motor. In addition, the motor position sensor may be a resolver configured to measure a position in an analog manner by using a change in voltage or an inductive position sensor configured to detect a position by using an electromagnetic induction principle. In the present disclosure, any type of sensors may be used as the motor position sensor.

The motor position sensor may measure an absolute position or an absolute angle value based on a particular position of the motor. Alternatively, the motor position sensor may detect a relative position with respect to a reference position. Alternatively, the motor position sensor may measure an electrical position of a rotor in a BLDC or Permanent Magnet Synchronous Motor (PMSM) motor.

A rotation angle in a single turn is a rotation angle between 0 degree and 360 degrees, and therefore a rotation angle can be represented in a single rotation turn only. Therefore, the absolute position of the motor which is over 360 degrees may not be identified because an angle of the rotor of the motor is reset after one full rotation turn. However, there is an absolute motor position sensor which can measure a position of the motor in multiple turns, but it has a complicated configuration and structure and a higher price.

Without using an absolute motor position sensor, some embodiments of the present disclosure may acquire an absolute position of the rack bar by using at least two motor position sensors which measure a relative position.

For example, when two motors move a same rack bar and have different rotational velocities, rotation angles measured by two motor position sensors of two motors, respectively, may be between 0 degree and 360 degrees. If the motor position sensor is not an absolute angle sensor, an angle measured by the motor position sensor is not recorded or stored, and a rotation angle detected by a motor position sensor of the first motor may be between 0 degree and 360 degrees and a rotation angle detected by a motor position sensor of the second motor may be between 0 degree and 360 degrees.

The electronic control device 110 may receive the rotation angle detected by the motor position sensor of the first motor and the rotation angle detected by the motor position sensor of the second motor. The electronic control device 110 estimates the absolute position of the rack bar by using two rotation angles (i.e., motor positions) detected by each of two motor positions sensors of two motors.

As described above, in certain embodiments of the present disclosure, the first motor and the second motor are operably connected to a single ball nut operably coupled to the rack bar and move the rack bar at different rotational velocities. Therefore, even though the first motor and the second motor rotate at different rotational velocities, the first motor and the second motor need to rotate the ball nut at the same velocity. Therefore, the motor pulley of the first motor and the motor pulley of the second motor may be configured by different in gear ratio.

The gear ratio may refer to, for example, but not limited to, a ratio of the numbers of threads or diameters of pulleys. For instance, the gear ratio may be a ratio between the number of threads or a diameter of a motor pulley connected to a motor shaft of the first motor and the number of threads or a diameter of a motor pulley connected to a motor shaft of the second motor. There may be a substantial difference in gear ratio in case that the diameters of the motor pulleys are different.

The first motor and the second motor may rotate at different rotational velocities, and the electronic control device 110 may receive different motor rotation information from the motor position sensors of the first and second motors.

The electronic control device 110 may determine the absolute position of the rack bar by using preset information and motor rotation information of the first and second motors.

For example, a difference in rotational velocity between the two motors may vary depending on the absolute position of the rack bar.

For example, the electronic control device 110 may determine the absolute position of the rack bar by monitoring a change in the rotation information of the two motors. For example, the electronic control device 110 may determine the position of the rack bar by using Equation 1.

$$R = \frac{K}{360} \times θ + K \times n \qquad [ Equation 1 ]$$

R represents a linear position of the rack bar, θ represents a phase difference between first rotation information of the first motor and second rotation information of the second motor, K represents a distance by which the rack bar is moved while a phase difference between the first rotation information and the second rotation information changes from 0 and a next phase difference becomes 0 in case that the rack bar moves in one direction, and n represents the number of times the phase difference becomes 0 while the rack bar moves in one direction.

That is, the electronic control device 110 may cumulatively identify the position of the rack bar by consistently monitoring the phase difference between the first rotation information of the first motor and the second rotation information of the second motor and recording the number of times the phase difference becomes 0.

In another example, the electronic control device 110 may determine the position of the rack bar based on a preset reference value. A movable range of the rack bar is structurally limited. Therefore, the plurality of positions of the rack bar corresponding to the first rotation information of the first motor and the second rotation information of the second motor can be calculated in advance and stored in the form of a table or other data formats in memory of the electronic control device 110.

When the first rotation information of the first motor and the second rotation information of the second motor are received, the electronic control device 110 may estimate the absolute position of the rack bar by comparing the first rotation information of the first motor and the second rotation information of the second motor with pre-stored data. However, in this case, the first rotation information and the second rotation information need to be designed to have different values in a linearly movable range of the rack bar. Therefore, a difference in gear ratio between the first motor and the second motor needs to be set so that the first rotation information of the first motor and the second rotation information of the second motor do not overlap at or correspond to two or more absolute positions of the rack bar.

For example, the electronic control device 110 may estimate the absolute position of the rack bar by using Equation 2.

$$A = \{ ( First Rotation Information + m ) \times First Gear Ratio \} \qquad [ Equation 2 ]$$

$$B = \{ ( Second Rotation Information + m ) \times Second Gear Ratio \}$$

$$Rack bar position R = intersection of A and B .$$

Here, m is a natural number equal to or larger than 1 and equal to or smaller than a maximum movable distance of the rack bar.

FIG. 19 is a graph for explaining a method of estimating a position of a rack bar using a difference between first rotation information of a first motor and second rotation information of a second motor. FIG. 19 illustrates relationship between the first rotation information of the first motor and the second rotation information of the second motor and a linear position of a rack bar in a movable range of the rack bar from 0 to 75 mm. As described above, the first gear ratio and the second gear ratio may be set so that the first rotation information of the first motor and the second rotation information of the second motor do not overlap or correspond to multiple positions of the rack bar.

Referring to FIGS. 20 to 25, the steering column 100 may include a mounting bracket 203, a tilt device 207, a tilt device 207, a telescope device 205, a rotation angle limiting device 125, a steering column motor 120, and the electronic control device 110. The mounting bracket 203 may be fixed to the body of the vehicle The tilt device 207 and the telescope device 205 may be configured to adjust the angle and length of the steering column 100 for the convenience of the driver. The rotation angle limiting device 125 may be configured to limit the rotation angle of the steering shaft 103. The steering column motor 120 may be coupled to the steering shaft 103 to rotate the steering shaft 103. The electronic control device 110 may be configured to transmit output values using electric signals received from the angle sensor 105 and the torque sensor 107 as input values.

The steering column 100 may further include a coupler 103a that couples a shaft 120a of the steering column motor 120 and the steering shaft 103.

The coupler 103a has a substantially cylindrical shape and has teeth 103b formed on an inner peripheral surface thereof that extends in a longitudinal or axial direction of the steering shaft 103. Teeth that mesh with the outer peripheral surface of the end of the steering shaft 103 and the outer peripheral surface of the shaft 120a of the steering column motor 120 are also formed on the outer peripheral surface of the end and the outer peripheral surface of the shaft 120a.

Therefore, the shaft 120a of the steering column motor 120 is tooth-coupled to the inner side of one end of the coupler 103a, and the steering shaft 103 is tooth-coupled to the inner side of the other end of the coupler 103a, thereby enabling the shaft 120a and the steering shaft 103 to be coupled in a manner that prevents idle rotation.

An integrated bearing 208 may be coupled to the shaft 120a of the steering column motor 120 to support the rotation of the shaft 120a, and may be supported by a motor housing accommodating the steering column motor 120.

The angle sensor 105 is coupled to the end of the steering shaft 103 coupled to the coupler 103a at a position adjacent to the coupler 103a, the rotation angle limiting device 125 is disposed on the side surface of the angle sensor 105, and the bearing 211 is coupled between the housing 125a and the steering shaft 103 to support the rotation of the steering shaft 103.

The rotation angle limiting device 125 may include a first rotatable member 230, a second rotatable member 220, a housing 125a, and stopper 125b. The first rotatable member 230 may have a fixing hole 231a coupled to the steering shaft 103 and configured to be rotatable in conjunction with the steering shaft 103. The second rotatable member 220 may have a through hole 221a rotatably coupled to the steering shaft 103 and supported by one end of the first rotatable member 230 and may be configured to be rotatable by rotation of the steering shaft 103. The housing 125a may accommodate the angle sensor 105 and the rotation angle limiting device 125 and include an inner peripheral surface supporting one end of the second rotatable member 220. The stopper 125b may be configured to limit a rotatable range of the steering shaft 103.

The angle sensor 105, the first rotatable member 230, and the second rotatable member 220 are accommodated in the inner space of the housing 125a, the housing 125a has a small diameter portion 125a-1 with a reduced inner diameter at one end thereof, and a bearing 211 that supports one end of the steering shaft 103 may be coupled to the small diameter portion 125a-1 of the housing 125a.

By accommodating the angle sensor 105 and the rotation angle limiting device 125 inside the housing 125a, the stable operation of the angle sensor 105 and the rotation angle limiting device 125 may be maintained and their durability may be improved.

The steering column motor 120 is coupled to the other end of the housing 125a.

The inner ring of the bearing 211 that supports the steering shaft 103 may be supported in a first axial direction of the steering shaft 103 by an inner ring fixing member 212 that is fixed (e.g., screw-coupled) to the outer peripheral surface of the steering shaft 103.

In addition, the outer ring of the bearing 211 may be supported in a second axial direction of the steering shaft 103, which is opposite to the first direction of the steering shaft 103, by an outer ring fixing member 213 (e.g. a ring plate) coupled to a fixing groove 125a-2 formed on the inner peripheral surface of the housing 125a.

Therefore, since the inner ring and outer ring of the bearing 211 are supported in two opposite directions of the steering shaft 103 by the inner ring fixing member 212 and the outer ring fixing member 213, the bearing 211 may continuously and stably support the rotation of the steering shaft 103 at an accurate position, and the precision and durability of the rotation angle limiting device 125 and the angle sensor 105 may be improved.

The outer ring fixing member 213 has a substantially ring-shaped configuration having a cutout portion on one side inserted in or coupled to the fixing groove 125a-2 of the housing 125a in a state in which the outer ring fixing member 213 is elastically deformed so as to have a reduced diameter. Therefore, the outer ring fixing member 213 is coupled to the fixing groove 125a-2 in a manner such that a restoring force, which urges the outer ring fixing member 213 to its original diameter, prevents from disengaging from the fixing groove 125a-2.

The first rotatable member 230 may be coupled to the steering shaft 103 by press-fitting the steering shaft 103 into the fixing hole 231a, or may be interlockingly coupled by forming teeth, oriented along the axial direction of the steering shaft 103, on the inner peripheral surface of the fixing hole 231a and on the outer peripheral surface of the steering shaft 103.

The first rotatable member 230 fixed to the steering shaft 103 is supported in the axial direction of the steering shaft 103 by the shaft fixing member 255 screw-coupled to the outer peripheral surface of the steering shaft 103, thereby preventing axial displacement of the first rotatable member 230 and maintaining the first rotatable member 230 in an accurate position statea.

In addition, the rotation angle limiting device 125 may further include a rotation support member 240 coupled to the through hole 221a of the second rotatable member 220 and the outer peripheral surface of the steering shaft 103 to support the rotation of the second rotatable member 220.

The rotation support member 240 has a protrusion 240a protruding from the inner peripheral surface of the rotation support member 240. The protrusion 240a of the rotation support member 240 is inserted into an insertion groove 240b of the steering shaft 103 so that the second rotatable member 220 may be supported by the first rotatable member 230 while rotating in the fixed position

The rotation support member 240 has a substantially ring-shaped configuration with a cutout 245 formed on one side and is coupled to the second rotatable member 220. A circumferential groove 243 is provided on the outer peripheral surface of the rotation support member 240, and the inner peripheral surface of the through hole 221a provided in the second rotation member 220 is inserted into or coupled to the circumferential groove 243.

In addition, the rotation support member 240 is elastically deformed to reduce its diameter, and is then coupled to the through hole 221a of the second rotation member 220. Therefore, the rotation support member 240 is retained within the through hole 221a by a restoring force that urges the rotation support member 240 to return its original diameter, thereby preventing disengagement from the through hole 221a.

Accordingly, when the rotation support member 240 rotates together with the second rotatable member 220, the rotation support member 240 may rotate in phase with the second rotatable member 220 without idle rotation.

The first rotatable member 230 may include a ring-shaped first main body 231 having a fixing hole 231a, and a first support portion 233 extending radially from the outer peripheral surface of the first main body 231 to support and rotate the second rotatable member 220.

The first support portion 233 has a substantially fan-shaped configuration extending radially from the first main body 231, and may include step support portions 235a, which are formed in a stepped shape by reducing the thickness of the first rotatable member 230 (e.g., by cutting a part of the first rotatable member 230) and are provided on both sides of the first support portion 233.

When the first rotatable member 230 rotates in conjunction with the steering shaft 103, the step support portions 235a provided on both sides of the first support portion 233 support one and the other sides of the second rotable member 220 according to the rotation direction of the first rotatable member 230 and may rotate in one direction (for example, clockwise) and the other direction (for example, counterclockwise).

The second rotatable member 220 supported by the first rotatable member 230 and configured to be rotatable by the first rotatable member 230 may include a ring-shaped second main body 221 having a through hole 221a, and a second support portion 223 extending radially from the outer peripheral surface of the second main body 221 and protruding toward both sides of the second support portion 223 in the axial direction of the steering shaft 103 and supported by the first support portion 233.

The second support portion 223 is formed to extend in the radial direction of the second main body 221 and parts of the second support portion 223 protrude in opposite axial directions of the steering shaft 103, so that one side of the second support portion 223 is supported by the first support portion 233, and the other side of the second support portion 223 is supported by the stopper 125b of the housing 125a.

Accordingly, the second rotatable member 220, which is supported by the first rotatable member 230 and configured to be rotatable by the first rotatable member 230, is supported by one and the other circumferential sides of the stopper 125b, and the stopper 125b is configured to limit the rotatable angle of the steering shaft 103.

However, unlike the first rotatable member 230, the second rotatable member 220 is rotatably coupled to the steering shaft 103 via the rotating support member 240. Therefore, the second rotatable member 220 can rotates while not being damaged in a case where a force exceeding the normal operating force of the steering shaft 103 is applied or transferred.

An elastic member 225 such as an O-ring may be coupled to the second support portion 223, and a support groove 232 may be provided on the first support portion 233 to support one side of the elastic member 225 such that the elastic member 225 can be inserted into the support groove 232 of the first support portion 223.

As illustrated in FIG. 25, the stopper 125b may be provided with a seating groove 125b-1 to support the other side of the elastic member 225.

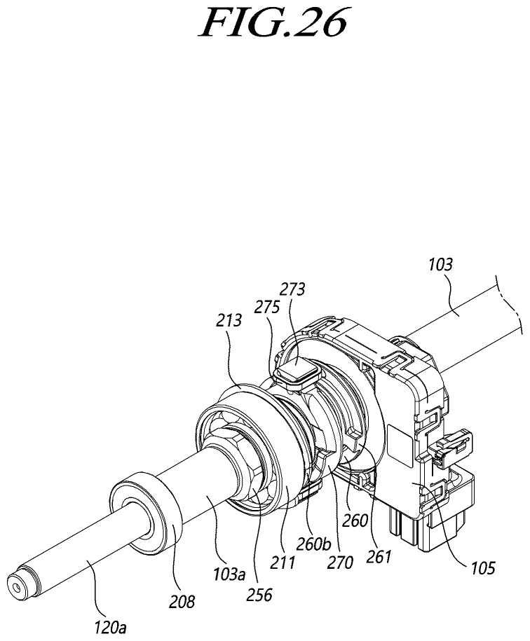

Referring to FIGS. 26 to 30 together with FIG. 20, the steering apparatus according to an embodiment may include the steering shaft 103, the angle sensor 105, the rotation angle limiting device 125, and the steering column motor 120. The steering wheel (101 of FIG. 1) is directly or indirectly coupled to the steering shaft 103. The angle sensor 105 may be coupled to the steering shaft 103 and may be configured to detect the rotation angle and/or direction of the steering shaft 103 and transmit an electrical signal indicative of the detected rotational angle and/or direction. The rotation angle limiting device 125 may be coupled to the steering shaft 103 and be configured to limit the rotation angle of the steering shaft 103. The steering column motor 120 may be coupled to the steering shaft 103 and be configured to rotate the steering shaft 103.

The rotation angle limiting device 125 may include a screw cylinder 260a, an outer threaded portion 263, a cylinder nut 270, a guide 273, and a housing 125a. The screw cylinder 260a may have a substantially cylindrical shape to which the steering shaft 103 is coupled. The outer threaded portion 263 may be formed on the outer peripheral surface of the outer threaded portion 263 and be configured to rotate in conjunction with the steering shaft 103. The cylinder nut 270 may have an inner threaded portion 277 formed on the inner peripheral surface of the cylinder nut 270 to engage the outer threaded portion 263. The guide 273 may be formed on the outer peripheral surface of the guide 273, extend radially, and be configured to be movable in the axial direction of the steering shaft 103 in response to rotation of the screw cylinder 260a. The housing 125a may be coupled with the steering column motor 120, accommodate the screw cylinder 260a and the cylinder nut 270, and have a guide groove 125a-3 formed on the inner peripheral surface of the housing 125a in which a guide 273 is inserted and supported.

The housing 125a accommodates the rotation angle limiting device 125 in the inner space, and the bearing 211 that supports the rotation of the steering shaft 103 may be coupled between the coupler 103a and the rotation angle limiting device 125.

Then, the angle sensor 105 is positioned around the steering shaft 103 and coupled to the steering shaft 103 on the outer side of the housing 125a, and the angle sensor 105 is supported in the axial direction of the steering shaft 103 by a first enlarged portion 103-1 formed on the outer peripheral surface of the steering shaft 103 so that the position of the angle sensor 105 can be fixed.

Therefore, even if an impact from the road surface is applied or transmitted to the steering column 100 while the vehicle is traveling, the angle sensor 105 remains in its fixed position and does not interfere with or collide with the screw cylinder 260a.

The screw cylinder 260a is formed in a substantially cylindrical shape so that the steering shaft 103 may be inserted and coupled in the screw cylinder 260a. The inner peripheral surface of the screw cylinder 260a is provided with teeth 264 that are formed in the longitudinal or axial direction of the steering shaft 103 so that the screw cylinder 260a and the steering shaft 103 may be interlocking-coupled to one another.

In addition, teeth formed in the longitudinal or axial direction of the steering shaft 103 are provided on the outer peripheral surface of the steering shaft 103 so that the screw cylinder 260a and the steering shaft 103 may be interlocking-coupled to one another.

In addition, the outer threaded portion 263 is provided on the outer peripheral surface of the screw cylinder 260a, and the inner threaded portion 277 is provided on the inner peripheral surface of the cylinder nut 270. Therefore, if the screw cylinder 260a rotates in conjunction with the steering shaft 103, the cylinder nut 270 can move in both opposite axial directions of the steering shaft 103 while the guide 273 of the cylinder nut 270 is supported by the guide groove 125a-3 of the housing 125a.

An elastic member 275, such as an O-ring, may be coupled to the outer peripheral surface of the guide 273 to reduce noise that may occur if the guide 273 directly contacts the guide groove 125a-3.

A nut support end 267 that has an enlarged diameter and stops movement of the cylinder nut 270 in one direction may be provided on one side of the screw cylinder 260a, and a nut support member 260b that stops movement of the cylinder nut 270 in an opposite direction may be coupled to the other side of the screw cylinder 260a.

The other end of the screw cylinder 260a is provided with an extension end 265 extending in the axial direction of the steering shaft 103 and is coupled to a coupling hole 268 formed in the nut support member 260b. Therefore, when the screw cylinder 260a rotates, the nut support member 260b also rotates in conjunction with the rotation of the screw cylinder 260a.

In addition, a first protrusion 271a and a second protrusion 271b, protruding in mutually opposite directions along the axial direction of the steering shaft 103, are provided on one side and the other side of the cylinder nut 270, respectively. In addition, a first stop protrusion 269 and a second stop protrusion 261, protruding in mutually opposite directions to face each other along the axial direction of the steering shaft 103, are provided on the inner surface of the nut support member 260b and the inner surface of the nut support end 267, respectively.

Therefore, when the cylinder nut 270 moves toward the steering shaft 103 by the rotation of the screw cylinder 260a, the first protrusion 271a is supported by the first stop protrusion 269 and then the movement of the cylinder nut 270 stops, and when the cylinder nut 270 moves in a direction away from the steering shaft 103, the second protrusion 271b is supported by the second stop protrusion 261 and then the movement of the cylinder nut 270 stops, thereby limiting the rotation of the steering shaft 103.

A first enlarged portion 103-1 having an enlarged diameter may be provided on one outer peripheral surface of the steering shaft 103. The first enlarged portion 103-1 may protrude from the outer peripheral surface of the steering shaft 103 in a radial direction. The angle sensor 105 may be disposed on one side of the first enlarged portion 103-1, and the nut support end 267 may be disposed on the other side of the first enlarged portion 103-1 to be supported in the axial direction of the steering shaft 103.

The angle sensor 105 and the screw cylinder 260a are arranged on one side and the other side of the first enlarged portion 103-1, respectively, in order to prevent the displacement of the positions of the parts that may occur during assembly or operation of the steering column 100.

A second enlarged portion 103-2 having an enlarged diameter may be provided on the other outer peripheral surface of the steering shaft 103. The second enlarged portion 103-2 may protrude from the outer peripheral surface of the steering shaft 103 in a radial direction. A nut support member 260b may be disposed on one side of the second enlarged portion 103-2, and a bearing 211 may be disposed on the other side of the second enlarged portion 103-2 to be supported in the axial direction of the steering shaft 103.

The nut support member 260b and the bearing 211 are arranged on one side and the other side of the second enlarged portion 103-2, respectively, to prevent the displacement of the assembly position of the bearing 211 and the nut support member 260b or the position of the parts that may occur during operation of the steering column 100.

The outer ring of the bearing 211 may be supported in the axial direction of the steering shaft 103 by the outer ring fixing member 213 (e.g. a ring shaped plate) coupled to the fixing groove 215a-5 formed on or recessed from the inner peripheral surface of the housing 125a, and the inner ring of the bearing 211 may be supported in the axial direction of the steering shaft 103 by the inner ring fixing member 256 coupled (e.g. screw-coupled) to the outer peripheral surface of the steering shaft 103.

Because the bearing 211 may continuously support the rotation of the steering shaft 103 in the correct position, the precision and durability of the rotation angle limiting device 125 and the angle sensor 105 may also be enhanced.

The steering column 100 may further include the coupler 103a that couples the shaft 120a of the steering column motor 120 and the steering shaft 103.

The coupler 103a may be formed in a substantially cylindrical shape and have teeth 103b formed on an inner peripheral surface of the coupler 103a that extends in the longitudinal direction or the axial direction of the steering shaft 103, such that the shaft 120a of the steering column motor 120 is tooth-coupled to the inner side of one end of the coupler 103a and the steering shaft 103 may be tooth-coupled to the inner side of the other end of the coupler 103a.

The integral bearing 208 may be coupled to the shaft 120a of the steering column motor 120 and supported by the motor housing.

According to some embodiments of the present disclosure, even in the absence of a mechanical connection between a steering shaft and a road wheel in a steer-by-wire steering apparatus, the driver's steering will may be stably transmitted to a rack bar, and the rotation of the rack bar due to the rotational torque of a ball nut in response to the driver's operation of a steering wheel may be prevented.

In addition, according to certain embodiments of the present disclosure, even in the absence of a pinion shaft, the precise position of a rack bar may be estimated so as not to affect the behavior of the vehicle.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments illustrated, but is to be accorded the widest scope consistent with the claims.

What is claimed is:

1. A vehicle steering apparatus, comprising:
a rotable nut operably coupled to a rack bar and configured to linearly move the rack bar by rotation of the rotatable nut;
a first nut pulley provided on an outer surface of the rotatable nut;
a second nut pulley provided on the outer surface of the rotatable nut;
a first motor pulley of a first motor operably connected to the first nut pulley through a first belt;
a second motor pulley of a second motor operably connected to the second nut pulley through a second belt;
an angle sensor included in a steering column, positioned around a steering shaft, and configured to detect a rotational angle and/or direction of the steering shaft and transmit a signal indicative of the detected rotational angle and/or direction of the steering shaft; and
a controller configured to control the first and second motors in response to the signal indicative of the detected rotational angle and/or direction of the steering shaft.

2. The vehicle steering apparatus of claim 1, wherein the steering column further includes:
a rotation angle limiting device coupled to the steering shaft and including a stopper configured to limit a rotable range of the steering shaft, and
a steering column motor coupled to the steering shaft and configured to rotate the steering shaft.

3. The vehicle steering apparatus of claim 2, wherein the steering column further includes a coupler connecting between a shaft of the steering column motor and the steering shaft.

4. The vehicle steering apparatus of claim 3, wherein the coupler has a substantially cylindrical shape and comprises teeth formed on an inner surface of the coupler that extend in an axial direction of the steering shaft, such that the shaft of the steering column motor is tooth-coupled to one end of the inner surface of the coupler and the steering shaft is tooth-coupled to another end of the inner surface of the coupler.

5. The vehicle steering apparatus of claim 2, wherein the rotation angle limiting device includes:
a first rotatable member having a fixing hole coupled to the steering shaft and configured to be rotatable with the steering shaft,
a second rotatable member having a through hole, rotatably coupled to the steering shaft and supported by one end of the first rotatable member, and configured be rotatable in response to rotation of the steering shaft, and
a housing accommodating the angle sensor and the rotation angle limiting device and including an inner surface supporting one end of the second rotatable member and the stopper.

6. The vehicle steering apparatus of claim 5, wherein the angle sensor, the first rotatable member, and the second rotatable member are accommodated in an inner space of the housing, the housing includes, at one end, a small diameter portion having a smaller inner diameter than an inner diameter of a portion of the housing adjacent to the small diameter portion, and a bearing supporting one end of the steering shaft is coupled to the small diameter portion of the housing.

7. The vehicle steering apparatus of claim 6, wherein an inner ring of the bearing is supported in an axial direction of the steering shaft by an inner ring fixing member coupled to an outer surface of the steering shaft and projecting outward relative to the outer surface of the steering shaft.

8. The vehicle steering apparatus of claim 6, wherein an outer ring of the bearing is supported in an axial direction of the steering shaft by an outer ring fixing member coupled to a fixing groove formed on the inner surface of the housing and projecting inward relative to the inner surface of the housing.

9. The vehicle steering apparatus of claim 5, wherein the first rotatable member includes:
a ring-shaped first main body having the fixing hole, and
a first support portion extending radially from an outer surface of the first main body and configured to support the second rotatable member to rotate the second rotatable member.

10. The vehicle steering apparatus of claim 9, wherein the second rotatable member includes:
a ring-shaped second main body having the through hole, and
a second support portion extending radially from an outer surface of the second main body and protruding toward the steering shaft and supported by the first support portion.

11. A vehicle steering apparatus comprising:
a steering shaft coupled to a steering wheel;
an angle sensor positioned around the steering shaft, and configured to detect a rotational angle and/or direction of the steering shaft and transmit a signal indicative of the detected rotational angle and/or direction of the steering shaft;
a rotation angle limiting device coupled to the steering shaft and including a stopper configured to limit a rotatable range of the steering shaft; and
a steering column motor coupled to the steering shaft and configured to rotate the steering shaft.

12. The vehicle steering apparatus of claim 11, wherein the rotation angle limiting device includes:
a screw cylinder, to which the steering shaft is coupled, the screw cylinder having an outer threaded portion formed on an outer surface of the screw cylinder and configured to be rotatable with the steering shaft,
a cylinder nut having an inner threaded portion formed on an inner surface of the cylinder nut engaged with the outer threaded portion of the screw cylinder and a guide extending radially from an outer surface of the cylinder nut, and configured to be moveable in an axial direction of the steering shaft in response to rotation of the screw cylinder, and
a housing coupled to the steering column motor, accommodating the screw cylinder and the cylinder nut, and having a guide groove formed on an inner surface of the housing in which the guide of the cylinder nut is inserted.

13. The vehicle steering apparatus of claim 12, wherein a nut support end having an enlarged diameter larger than a diameter of a portion of the screw cylinder adjacent to the nut support end and configured to stop movement of the cylinder nut in one direction is provided on one side of the screw cylinder, and a nut support configured to stop the movement of the cylinder nut in an opposite direction is coupled to another side of the screw cylinder.

14. The vehicle steering apparatus of claim 13, wherein a first enlarged portion having an enlarged diameter larger than a diameter of a portion of the steering shaft adjacent to the first enlarged portion is provided on an outer surface of the steering shaft, the angle sensor is located on one side of the first enlarged portion of the steering shaft, and the nut support end is located on another side of the first enlarged portion of the steering shaft such that the nut support end is supported in the axial direction of the steering shaft.

15. The vehicle steering apparatus of claim 11, further comprising a coupler connecting between the shaft of the steering column motor and the steering shaft.

16. The vehicle steering apparatus of claim 15, wherein the coupler has a substantially cylindrical shape and comprises teeth formed on an inner surface of the coupler that extend in the axial direction of the steering shaft, such that the shaft of the steering column motor is tooth-coupled to one end of the inner surface of the coupler and the steering shaft is tooth-coupled to another end of the inner surface of the coupler.

17. The vehicle steering apparatus of claim 11, wherein the rotation angle limiting device includes:
a first rotatable member having a fixing hole coupled to the steering shaft and configured to be rotatable with the steering shaft,
a second rotatable member having a through hole, rotatably coupled to the steering shaft and supported by one end of the first rotatable member, and configured to be rotatable in response to rotation of the steering shaft, and
a housing accommodating the angle sensor and the rotation angle limiting device and including an inner surface supporting one end of the second rotatable member and the stopper.

18. The vehicle steering apparatus of claim 17, wherein the angle sensor, the first rotatable member, and the second rotatable member are accommodated in an inner space of the housing, the housing includes, at one end, a small diameter portion having a smaller inner diameter than an inner diameter of a portion of the housing adjacent to the small diameter portion, and a bearing supporting one end of the steering shaft is coupled to the small diameter portion of the housing.

19. The vehicle steering apparatus of claim 17, wherein the rotation angle limiting device further includes a rotation support coupled to the through hole of the second rotatable member and an outer surface of the steering shaft to support rotation of the second rotatable member.

20. The vehicle steering apparatus of claim 17, wherein the first rotatable member includes:
a ring-shaped main body having the fixing hole, and
a support portion extending radially from an outer surface of the ring-shaped main body and configured to support the second rotatable member to rotate the second rotatable member.
